(19) United States
(12) Patent Application Publication
(10) Pub. No.: US 2017/0365850 A9
(43) Pub. Date: Dec. 21, 2017

(54) NANOCOMPOSITE, ELECTRODE CONTAINING THE NANOCOMPOSITE, AND METHOD OF MAKING THE NANOCOMPOSITE

(71) Applicant: NANYANG TECHNOLOGICAL UNIVERSITY, Singapore (SG)

(72) Inventors: Rachid YAZAMI, Singapore (SG); Yin Ting TENG, Singapore (SG)

(73) Assignee: Nanyang Technological University, Singapore (SG)

(21) Appl. No.: 15/111,596

(22) PCT Filed: Jan. 14, 2015
(86) PCT No.: PCT/SG2015/000008

§ 371 Date: Jul. 14, 2016

Related U.S. Application Data
(60) Provisional application No. 61/927,248, filed on Jan. 14, 2014.

(51) Int. Cl. H01M 4/58; H01M 10/052; H01M 4/62; H01M 4/04; H01M 4/36; H01M 4/1397; H01M 4/136; H01M 10/0525; H01G 11/50

(52) U.S. Cl. CPC H01M 4/582; H01M 10/0525; H01M 10/052; H01M 4/625; H01M 4/623; H01G 11/50; H01M 4/366; H01M 4/1397; H01M 4/136; H01M 4/049; H01M 4/622

(57) ABSTRACT

A nanocomposite is provided. The nanocomposite includes an electrically conductive nanostructured material; and metal fluoride nanostructures having the general formula M^{(I)}ₓM^{(II)}₁₋ₓF_{2+y-zn} arranged on the electrically conductive nanostructured material, wherein M^{(I)} and M^{(II)} are independently transition metals, n is a stoichiometric coefficient, and wherein i) x=0, 0<y≦2, and z=0; or ii) 0<x<1, 0≦y≦2, z≧0, and M^{(I)} and M^{(II)} are different transition metals. An electrode including the nanocomposite and method of preparing the nanocomposite are also provided.

### CROSS-REFERENCE TO RELATED APPLICATION

This application claims the benefit of priority of U.S. provisional application No. 61/927,248 filed on 14 Jan. 2014, the content of which is incorporated herein by reference in its entirety for all purposes.

### TECHNICAL FIELD

The invention relates to a nanocomposite, electrode containing the nanocomposite, and method of making the nanocomposite.

### BACKGROUND

Transition metal fluorides have been gaining interest as reversible positive electrodes for rechargeable lithium batteries in recent years due to their high theoretical electromotive force (e.m.f) values and ability to transfer more than 1 electron per formula unit. The intrinsically poor electronic transport properties due to the large band gap of transition metal fluorides, however, have impeded use of these materials in commercial cells. In addition, a reaction product of the conversion reaction, lithium fluoride (LiF), is highly insulating. This has prevented use of metal fluorides in their macro crystalline state.

In view of the above, there exists a need for an improved material suitable as electrodes for use in batteries such as lithium batteries that overcomes or at least alleviates one or more of the above-mentioned problems.

### SUMMARY

In a first aspect, a nanocomposite is, provided. The nanocomposite comprises
a) an electrically conductive nanostructured material; and
b) metal fluoride nanostructures having the general formula M^{(I)}ₓM^{(II)}₁₋ₓF_{2+y-zn} arranged on the electrically conductive nanostructured material, wherein M^{(I)} and M^{(II)} are independently transition metals, n is a stoichiometric coefficient, and wherein
   i) x=0, 0<y≦2, and z=0; or
   ii) 0<x<1, 0≦y≦2, z≧0, and M^{(I)} and M^{(II)} are different transition metals.

In a second aspect, an electrode is provided. The electrode comprises a nanocomposite according to the first aspect.

In a third aspect, a method of preparing a nanocomposite is provided. The method comprises
a) providing metal fluoride nanostructures having the general formula M^{(I)}ₓM^{(II)}₁₋ₓF_{2+y-zn}, wherein M^{(I)} and M^{(II)} are independently transition metals, n is a stoichiometric coefficient, and wherein
   i) x=0, 0<y≦2, and z=0; or
   ii) 0<x<1, 0≦y≦2, z≧0, and M^{(I)} and M^{(II)} are different transition metals;

and
b) arranging the metal fluoride nanostructures on an electrically conductive nanostructured material to obtain the nanocomposite.

In a fourth aspect, use of a nanocomposite according to the first aspect in a electrochemical cell, a symmetric supercapacitor, an asymmetric supercapacitor, a primary battery, or a rechargeable battery is provided.

### BRIEF DESCRIPTION OF THE DRAWINGS

The invention will be better understood with reference to the detailed description when considered in conjunction with the non-limiting examples and the accompanying drawings, in which:

FIG. 1 shows transmission electron microscopy (TEM) characterization of NiF₂, where (A) is the selected area electron diffraction (SAED) image taken for as synthesized NiF₂. The respective d-spacings (as measured in the SAED image) are listed in Å, where values (from top to bottom) are 3.515, 2.745, 2.406, 2.232, 1.844, 1.760, 1.656, 1.481, and 1.203.

FIG. 2 shows field emission scanning electron microscopy (FESEM) characterization of NiF₂, where (A) is the FESEM image for as synthesized NiF₂ at 300 K magnification; and (B) is the FESEM image for as synthesized NiF₂ at 150 K magnification. Scale bar in (A) and (B) denotes 50 nm and 100 nm respectively.

FIG. 3 shows FESEM characterization of CoF₂, where (A) is the FESEM image for as synthesized CoF₂ at 300 K magnification; (B) is the FESEM image for as synthesized CoF₂ at 150 K magnification; and (C) is the FESEM image for as synthesized CoF₂ at 40 K magnification. Scale bar in (A), (B) and (C) denotes 50 nm, 100 nm, and 200 nm respectively.

FIG. 4 shows TEM characterization of CoF₂, where (A) is the high resolution transmission electron microscopy (HRTEM) image for as synthesized carbon coated CoF₂. Measured d-spacing is 0.336 nm, which coincides with d-spacing of (110). Scale bar denote 10 nm.

FIG. 5 shows TEM characterization of Ni_{0.75}Co_{0.25}F₂, where (A) is the SAED image taken for as synthesized Ni_{0.75}Co_{0.25}F₂. The respective d-spacings (as measured in the SAED image) are listed in Å, where values (from top to bottom) are 3.509, 2.750, 2.403, 2.228, 1.850, 1.754, 1.632, 1.475, and 1.202.

FIG. 6 shows TEM-EDX mapping of Ni_{0.75}Co_{0.25}F₂, where (A) is the EDX spectrum obtained in the TEM; (B) is the secondary electron image obtained in the TEM; (C) is the fluorine element map; (D) is the cobalt element map; and (E) is the nickel element map. Scale bar in (B) to (E) denotes 200 nm.

FIG. 7 shows SEM characterization of Ni_{0.75}Co_{0.25}F₂, where (A) is the FESEM image for as synthesized Ni_{0.75}Co_{0.25}F₂ at 300 K magnification; (B) is the FESEM image for as synthesized Ni_{0.75}Co_{0.25}F₂ at 150 K magnification; and (C) is a table showing weight % and atomic % of F, Co, and Ni. Scale bar in (A) and (B) denotes 50 nm and 100 nm respectively.

FIG. 8 shows TEM characterization of Ni_{0.5}Co_{0.5}F₂, where (A) is the SAED image taken for as synthesized Ni_{0.5}Co_{0.5}F₂. The respective d-spacings (as measured in the SAED image) are listed in Å, where values (from top to bottom) are 3.452, 2.641, 2.319, 2.124, 1.776, 1.678, 1.590, and 1.419.

FIG. 9 shows TEM image for as synthesized carbon coated Ni_{0.5}Co_{0.5}F₂. Scale bar in the bottom left hand corner denotes 10 nm.

FIG. 10 shows transmission electron microscopy-energy-dispersive X-ray spectroscopy (TEM-EDX) mapping of Ni_{0.5}Co_{0.5}F₂, where (A) is the EDX spectrum obtained in the TEM; (B) is the secondary electron image obtained in the TEM; (C) is the nickel element map; (D) is the cobalt element map; and (E) is the fluorine element map. Scale bar in (B) to (E) denotes 200 nm.

FIG. 11 shows SEM characterization of Ni_{0.5}Co_{0.5}F₂, where (A) is the FESEM image for as synthesized Ni_{0.5}Co_{0.5}F₂ at 300 K magnification; (B) is the FESEM image for as synthesized Ni_{0.5}Co_{0.5}F₂ at 150 K magnification; and (C) is a table showing weight % and atomic % of F, Co and Ni. Scale bar in (A) and (B) denotes 50 nm and 100 nm respectively.

FIG. 12 shows TEM characterization of Ni_{0.25}Co_{0.75}F₂, where (A) is the SAED image taken for as synthesized Ni_{0.25}Co_{0.75}F₂. The respective d-spacings (as measured in the SAED image) are listed in Å, where values (from top to bottom) are 3.552, 2.787, 2.452, 2.261, 1.870, 1.788, 1.666, 1.498, 1.220, 1.180, and 1.140.

FIG. 13 shows transmission electron microscopy-energy-dispersive X-ray spectroscopy (TEM-EDX) mapping of Ni_{0.25}Co_{0.75}F₂, where (A) is the EDX spectrum obtained in the TEM; (B) is the secondary electron image obtained in the TEM; (C) is the nickel element map; (D) is the cobalt element map; and (E) is the fluorine element map. Scale bar in (B) to (E) denotes 100 nm.

FIG. 14 shows SEM images of Ni_{0.25}Co_{0.75}F₂, where (A) is the FESEM image for as synthesized Ni_{0.25}Co_{0.75}F₂ at 300 K magnification; (B) is the FESEM image for as synthesized Ni_{0.25}Co_{0.75}F₂ at 150 K magnification; and (C) is a table showing weight % and atomic % of F, Co and Ni. Scale bar in (A) and (B) denotes 50 nm and 100 nm respectively.

FIG. 15 is a X-ray diffraction (XRD) chart for CoF₂, Ni_{0.25}Co_{0.75}F₂, Ni_{0.5}Co_{0.5}F₂, Ni_{0.75}Co_{0.25}F₂, and NiF₂.

FIG. 16 depicts CoF₂ grown on nc3100 (CNT), where (A) is the FESEM image for. CoF₂ grown on nc3100 at 120 K magnification; and (B) is the transmission electron detector (TED) image for CoF₂ grown on nc3100 at 160 K magnification. CoF₂ was grown on nc3100 to improve electronic conductivity as CoF₂ is electronically insulating. Scale bar in (A) and (B) denotes 100 nm.

FIG. 17 depicts CoF₂ grown on PR24 LHT (CNF), where (A) is the FESEM image for CoF₂ grown on PR24 LHT at 120 K magnification; and (B) is the TED image for CoF₂ grown on PR24 LHT at 130 K magnification. CoF₂ was grown on PR 24 LHT to improve electronic conductivity since CoF₂ is electronically insulating. Scale bar in (A) and (B) denotes 100 nm.

FIG. 18 depicts CoF₃, where (A) is the FESEM image for CoF₃ at 5 K magnification; and (B) is the FESEM image for CoF₃ at 150 K magnification. Particle size of CoF₃ is about 30 nm to 50 nm. Scale bar in (A) and (B) denotes 1 μm and 100 nm respectively.

FIG. 19 is a XRD chart of (i) CoF₃, and (ii) CoF₂.

FIG. 20 shows (A) cyclic voltammogratn (CV) at 0.1 mVs⁻¹ for (i) first cycle, (ii) second cycle, (iii) third cycle, (iv) fourth cycle, and (v) fifth cycle; and (B) galvanostatic discharge-charge for operation of Li/LiPF₆/NiF₂.

FIG. 21 shows (A) cyclic voltammogram at 0.1 mVs⁻¹ for (i) first cycle, (ii) second cycle, (iii) third cycle, (iv) fourth cycle, and (v) fifth cycle; and (B) galvanostatic discharge-charge for operation of Li/LiPF₆/CoF₂.

FIG. 22 shows (A) cyclic voltammogram at 0.1 mVs⁻¹ for (i) first cycle, (ii) second cycle, (iii) third cycle, (iv) fourth cycle, and (v) fifth cycle; and (B) galvanostatic discharge-charge for operation of Li/LiPF₆/Ni_{0.75}Co_{0.25}F₂.

FIG. 23 shows (A) cyclic voltammogram at 0.1 mVs⁻¹ for (i) first cycle, (ii) second cycle, (iii) third cycle, (iv) fourth cycle, and (v) fifth cycle; and (B) galvanostatic discharge-charge for operation of Li/LiPF₆/Ni_{0.5}Co_{0.5}F₂.

FIG. 24 shows (A) cyclic voltammogram at 0.1 mVs⁻¹ for (i) first cycle, (ii) second cycle, (iii) third cycle, (iv) fourth cycle, and (v) fifth cycle; and (B) galvanostatic discharge-charge for operation of Li/LiPF₆/Ni_{0.25}Co_{0.75}F₂.

FIG. 25 shows 1^{st} cycle comparison of MF₂ with M^{(I)}ₓM^{(II)}₍₁₋ₓ₎F₂, where (A) is the 1^{8t} cycle galvanostatic discharge-charge profile for (i) CoF₂, (ii) Co_{0.75}Ni_{0.25}F₂, (iii) Co_{0.5}Ni_{0.5}F₂, (iv) Co_{0.25}Ni_{0.75}F₂, and (v) NiF₂; (B) 1^{st} cycle galvanostatic discharge profile for (i) CoF₂, (ii) Co_{0.75}Ni_{0.25}F₂, (iii) Co_{0.5}Ni_{0.5}F₂, (iv) Co_{0.25}Ni_{0.75}F₂, and (v) NiF₂, and (C) cyclic voltammogram at 0.1 mVs⁻¹ for (i) NiF₂, (ii) Ni_{0.75}Co_{0.25}F₂, (iii) Ni_{0.5}Co_{0.5}F₂, (iv) Ni_{0.25}Co_{0.75}F₂, and (v) CoF₂.

FIG. 26 shows long term cycling of CoF₂-CNT/CNF nanostructured composite, where (A) is the discharge-charge specific capacity of the CoF₂ nanoparticle aggregates deposited on (i) NC3100 (CNT) and (ii) PR24 LHT (CNF); and (B) is the % capacity retention of the CoF₂ nanoparticle aggregates deposited on (i) PR24LHT (CNF), and (ii) nc3100 (CNT).

FIG. 27 shows galvanostatic intermittent titration technique (GITT)-effect of growing CoF₂ on CNT, where (A) is the comparison of the 1^{st} cycle galvanostatic intermittent titration curves for (i) CoF₂ nanoparticle aggregates deposited on nc3100 (CNT), and (ii) CoF₂ nanoparticle aggregates hand mixed with nc3100 (CNT); and (B) is the comparison of the 2^{nd} cycle galvanostatic intermittent titration curves for (i) CoF₂ nanoparticle aggregates deposited on nc3100 (CNT), and (ii) CoF₂ nanoparticle aggregates hand mixed with nc3100 (CNT).

FIG. 28 shows GITT-effect of surface area, where (A) shows (i) 1^{st} cycle; and (ii) 2^{nd} cycle galvanostatic intermittent titration curves for the CoF₂ nanoparticle aggregates deposited on nc3100 (CNT); (B) shows (i) 1^{st} cycle, and (ii) 2^{nd} cycle galvanostatic intermittent titration curves for the CoF₂ nanoparticle aggregates deposited on PR24 LHT (CNF); and (C) is the comparison of the 1^{st} cycle galvanostatic intermittent titration curves between (i) CoF₂ nanoparticle aggregates deposited on nc3100 (CNT), and (ii) CoF₂ nanoparticle aggregates deposited on PR24 LHT (CNF).

FIG. 29 shows effect of ionic liquid electrolyte as compared to conventional electrolyte, where (A) is the galvanostatic discharge-charge profile in conventional 1M LiPF₆ (EC:DEC) (1:1 by volume) electrolyte; and (B) is the galvanostatic discharge-charge profile in 0.1M LiTFSI in PYR₁₄TFSI electrolyte.

FIG. 30 shows effect of ionic liquid electrolyte as compared to conventional electrolyte, where (A) is a comparison of the % capacity retention between (i) cells that use 1M LiPF₆ (EC:DEC) (1:1 by volume), and (ii) cells that use 0.1M LiTFSI in PYR₁₄TFSI; and (B) shows the discharge-charge specific capacity of cells that use (i) 1M LiPF₆ (EC:DEC) (1:1 by volume), and (ii) cells that use 0.1M LiTFSI in PYR₁₄TFSI.

FIG. 31 shows 1^{st} cycle comparison of (i) CoF₃, with (ii) CoF₂. Electrolyte used for CoF₃ is 1M LiPF₆ (FEC:EMC), and electrolyte used for CoF₂ is 1M LiPF₆ (DEC:EC). CoF₃ is cycled at 69.4 mAg⁻¹, and CoF₂ is cycled at 50 mAg⁻¹.

FIG. 32 shows CV 1st cycle comparison of (i) CoF₃ with (ii) CoF₂. Electrolyte used for CoF₃ is 1M LiPF₆ (FEC:EMC), and electrolyte used for CoF₂ is 1M LiPF₆ (DEC:EC). CoF₃ is cycled at 69.4 mAg⁻¹, and CoF₂ is cycled at 50 mAg⁻¹.

FIG. 33 shows operation of Li/LiPF₆/CoF₃ in LiPF₆ (FEC:EMC) (1:1) by weight.

### DETAILED DESCRIPTION

In various embodiments disclosed herein, new nanostructured materials based on metal fluorides are provided. The nanostructured materials are suitable for use in cells or batteries. Advantageously, the materials have demonstrated outstanding electrochemical performances in lithium primary (disposal) and secondary (rechargeable) cells, with at least two times higher capacity than other fluorinated metal materials and metal oxide materials.

With the above in mind, various embodiments refer in a first aspect to a nanocomposite. The nanocomposite comprises an electrically conductive nanostructured material; and metal fluoride nanostructures having the general formula M^{(I)}ₓM^{(II)}₁₋ₓF_{2+y-zn} arranged on the electrically conductive nanostructured material, wherein M^{(I)} and M^{(II)} are independently transition metals, n is a stoichiometric coefficient, and wherein x=0, 0<y≦2, and z=0; or 0<x<1, 0≦y≦2, z≧0, and M^{(I)} and M^{(II)} are different transition metals.

As used herein, the term “nanocomposite” refers generally to a mixture of materials, where each material in the mixture has at least one dimension in the nanometer range. For example, a nanocomposite may comprise a mixture of zero dimensional materials such as nanoparticles; one dimensional materials such as nanorods, nanowires and nanotubes; and/or two dimensional materials such as nanoflakes, nanoflowers, nanodiscs and nanofilms.

The nanocomposite comprises an electrically conductive nanostructured material. In various embodiments, the electrically conductive nanostructured material is selected from the group consisting of carbon nanotubes, carbon nanofibers, and mixtures thereof. The carbon nanotubes and/or carbon nanofibers may form a highly efficient electron transport network in the nanocomposite, and may accordingly be used to improve electron transfer efficiency of electrodes formed using the nanocomposite. Further, the carbon nanotubes and/or carbon nanofibers may enhance mechanical strength and stability of the nanocomposite.

A carbon nanotube refers generally to a cylinder of rolled up graphitic sheets, and may exist in different forms, such as single-walled carbon nanotubes (SWNT), double-walled carbon nanotubes (DWNT), multi-walled carbon nanotubes (MWNT), or modified multi-walled carbon nanotubes. A carbon nanofiber, on the other hand, refers generally to solid or hollow fibers formed of carbon, apart from carbon nanotubes.

Single-walled carbon nanotubes refer generally to seamless cylinders formed from one graphite layer. For example, carbon nanotubes may be described as a graphite plane (so called graphene) sheet rolled into a hollow cylindrical shape so that the structure is one-dimensional with axial symmetry, and in general exhibiting a spiral conformation, called chirality. A single-wall nanotube may be defined by a cylindrical sheet with a diameter of about 0.7 nm to about 20 nm, such as about 1 nm to about 20 nm.

Double-walled carbon nanotubes consist of two layers of graphite sheets rolled in on to form a tube shape. The two layers of graphite sheets may form a concentric cylinder. The nanotubes are considered as a cross between SWNT and MWNT, as they may have the electronic properties of the SWNT and the mechanical strength of MWNT.

Multi-walled carbon nanotubes consist of multiple layers of graphite rolled in on to form a tube shape. The nanotubes may also exist in forms in which they have hydrophilic groups such as hydroxyl group, pyrenes, esters, thiols, amines, a carboxyl group and mixtures thereof on their surface.

Single-, double- and multi-walled carbon nanotubes may equally be used in a nanocomposite disclosed herein. In various embodiments, the carbon nanotubes are single-walled carbon nanotubes.

Size of the carbon nanotubes and/or carbon nanofibers may be characterized by their diameter and/or their length. The term “diameter” as used herein refers to the maximal length of a straight line segment, when applied to a cross-section of the figure, which passes through the center of the figure and terminating at the periphery. Average diameter of the carbon nanotubes and/or nanofibers may be calculated by dividing the sum of the diameter of each nanotube and/or nanofiber by the total number of nanotubes and/or nanofibers.

In various embodiments, the carbon nanotubes and/or carbon nanofibers have an average diameter in the range of about 50 nm to about 100 nm, such as about 50 nm to about 80 nm, about 50 nm to about 70 nm, about 50 nm to about 60 nm, about 60 nm to about 100 nm, about 70 nm to about 100 nm, about 80 nm to about 100 nm, about 90 nm to about 100 nm, about 55 nm, about 65 nm, about 75 nm, about 85 nm or about 95 nm.

The carbon nanotubes may be of any desired length, such as in the range from about 0.1 nm to about 10 μm, about 1 nm to about 5 μm, or 10 nm to about 1 μm. In some embodiments, the carbon nanotubes may be at least 1 μm or at least 2 μm, or between about 0.5 μm and about 1.5 μm, or between about 1 μm and about 5 μm.

In addition to the electrically conductive nanostructured material, the nanocomposite also comprises metal fluoride nanostructures having the general formula M^{(I)}ₓM^{(II)}₁₋ₓF_{2+y-zn} arranged on the electrically conductive nanostructured material. The metal fluoride nanostructures may be arranged on the electrically conductive nanostructured material to confer or to improve electronic conductivity of the metal fluroride nanostructures, as they may be electrically insulating.

In various embodiments, the metal fluoride nanostructures are chemically bonded to the electrically conductive nanostructured material. For example, the metal fluoride nanostructures may be covalently bonded to the electrically conductive nanostructured material.

M^{(I)} and M^{(II)} are independently transition metals. By the term “independently”, it is meant that the transition metal of M^{(I)} and M^{(II)} respectively is independently selected.

The term “transition metal” as used herein may refer to a metal in Group 3 to 12 of the Periodic Table of Elements, such as titanium (Ti), vanadium (V), niobium (Nb), tantalum (Ta), chromium (Cr), molybdenum (Mo), tungsten (W), manganese (Mn), iron (Fe), ruthenium (Ru), osmium (Os), iridium (Ir), nickel (Ni), copper (Cu), technetium (Tc), rhenium (Re), cobalt (Co), rhodium (Rh), iridium (Ti), palladium (Pd), platinum (Pt), silver (Ag), gold (Au), or zinc (Zn); a lanthanide such as europium (Eu), gadolinium (Gd), lanthanum (La), ytterbium (Yb), or erbium (Er); or a post-transition metal such as aluminum (Al), gallium (Ga), indium (In), tin (Sn), or lead (Pb).

In various embodiments, M^{(I)} and M^{(II)} are independently selected from the group consisting of Ti, V, Fe, Ni, Co, Mn, Cr, Cu, W, Mo, Nb, and Ta. In some embodiments, M^{(I)} is Ni and M^{(II)} is Co.

n is a stoichiometric coefficient, which may depend on oxidation state of M^{(I)} and M^{(II)}. In various embodiments, n is in the range of about 0 to about 1, such as about 0 to about 0.8, about 0 to about 0.5, about 0 to about 0.3, about 0.25 to about 1, about 0.5 to about 1, about 0.8 to about 1, about 0.3 to about 0.6, or about 0.2 to about 0.8.

x may be 0, or may have a value that is greater than 0 but less than 1.

In embodiments where 0<y≦2 and z=0, x is 0.

In embodiments where 0≦y≦2, z≧0, and M^{(I)} and M^{(II)} are different transition metals, x is greater than 0 but less than 1. For example, x may be in the range of about 0.01 to about 0.99, about 0.05 to about 0.99, about 0.1 to about 0.99, about 03 to about 0.99, about 0.5 to about 0.99, about 0.7 to about 0.99, about 0.01 to about 0.9, about 0.01 to about 0.7, about 0.01 to about 0.5, about 0.01 to about 0.3, about 0.1 to about 0.9, about 0.2 to about 0.8, about 0.3 to about 0.7, or about 0.4 to about 0.6.

y may be greater than or equal to 0, and less than or equal to 2.

In embodiments where x=0 and z=0, y is greater than 0 but less than or equal to 2. For example, y may be in the range of about 0.01 to about 2, such as about 0.05 to about 2, about 0.1 to about 2, about 0.5 to about 2, about 0.8 to about 2, about 1 to about 2, about 1.2 to about 2, about 1.4 to about 2, about 0.2 to about 1.8, about 0.5 to about 1.5, or about 0.8 to about 1.2.

In embodiments where 0<x<1, z≧0, and M^{(I)} and M^{(II)} are different transition metals, y is greater than or equal to 0 and less than or equal to 2. For example, in addition to the above stated ranges, y may also be in the range of about 0 to about 2, such as about 0 to about 1.8, about 0 to about 1.5, about 0 to about 1.2, about 0 to about 1, or about 0 to about 0.5.

z is greater than or equal to 0.

In embodiments where x=0 and 0<y≦2, z is equal to 0.

In embodiments where 0<x<1, 0≦y≦2, and M^{(I)} and M^{(II)} are different transition metals, z is greater than or equal to 0. For example, z may be in the range of about 0 to about 10, such as about 0 to about 8, about 0 to about 5, about 0 to about 2, about 0 to about 1, about 2 to about 10, about 5 to about 10, about 7 to about 10, about 2 to about 8, or about 4 to about 6.

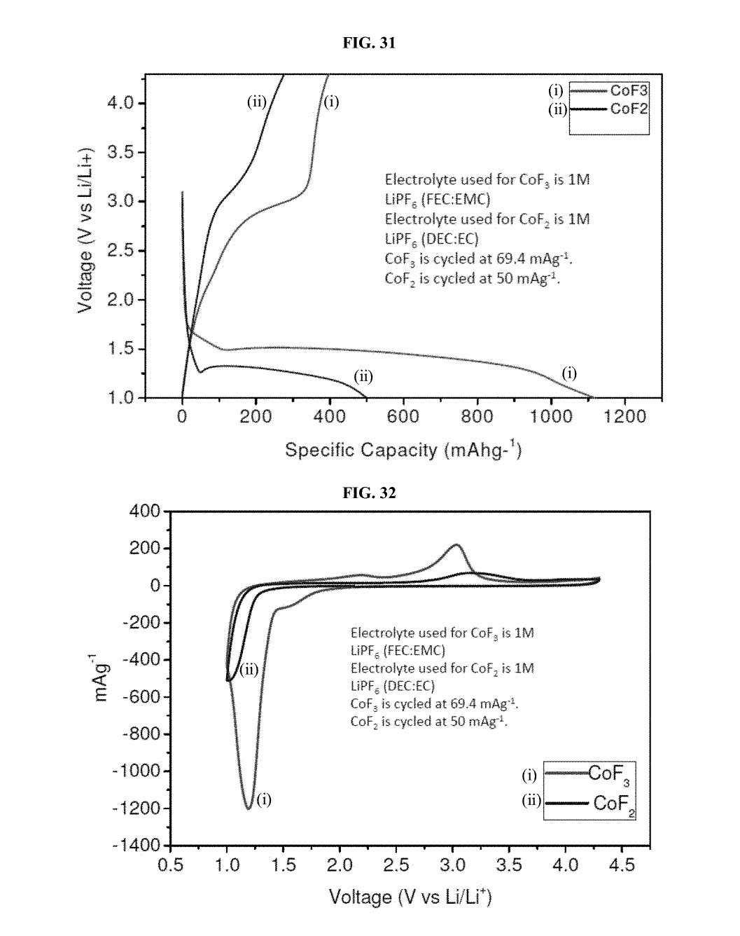

In specific embodiments, x=0, y=1, and z and/or n=0. Accordingly, the metal fluoride nanostructures may comprise or consist of CoF₃. It has been surprisingly found by the inventors that nanocomposites comprising CoF₃ provide a much better performance as compared to nanocomposites comprising CoF₂, for example. These comparisons are shown, for example in FIG. 31, where first cycle performance of CoF₂ with CoF₃ is plotted.

In further embodiments, 0<x<1, 0≦y≦2, z≧0, and M^{(I)} and M^{(II)} are different transition metals. Accordingly, the metal fluoride nanostructures may comprise or consist of NiₓCo₁₋ₓF₂, 0<x<1. It has been surprisingly found by the inventors that metal fluoride nanostructures containing two or more transition metals as disclosed herein is a single phase, and not a two-phase system in the form of (x(NiF₂)+(1−x)CoF₂). Advantageously, nanocomposites comprising the single phase metal fluoride nanostructures provide a decrease in the voltage delay effect, as well as a higher discharge specific capacity (700 mAh/g as compared to 550 mAh/g) and a higher discharge energy density (1050 Wh/kg). In various embodiments, the metal fluoride nanostructures comprise or consist of single phase metal fluoride nanostructures.

Apart from transition metals, the metal fluoride nanostructures may also contain other elements, for example, metalloids such as carbon (C), silicon (Si), and germanium (Ge), and/or alkaline metals such as magnesium (Mg) and calcium (Ca).

The metal fluoride nanostructures may have a size of less than 200 nm. Size of the metal fluoride nanostructures may be expressed in terms of an average value of the maximal dimension, wherein the term “maximal dimension” refers to the maximal length of a straight line segment passing through the center of a figure and terminating at the periphery. For example, maximal dimension of the metal fluoride nanostructures may be less than 200 nm, such as less than 150 nm, less than 100 nm, less than 50 nm, or less than 20 nm. In some embodiments, maximal dimension of the metal fluoride nanostructures is in the range of about 10 nm to about 200 nm, such as about 50 nm to about 200 nm, about 100 nm to about 200 nm, about 80 nm to about 150 nm, about 30 nm to about 50 nm, or about 20 nm to about 60 nm.

In various embodiments, each metal fluoride nanostructure has a maximal dimension of less than 200 nm, such as less than 150 nm, less than 100 nm, less than 50 nm, or less than 20 nm.

The metal fluoride nanostructures may comprise an outer layer of carbon. Each of the metal fluoride nanostructures may contain a layer of carbon coated thereon. In various embodiments, the layer of carbon on each metal fluoride nanostructure has a thickness in the range of about 1 nm to about 30 nm, such as about 1 nm to about 20 nm, about 1 nm to about 10 nm, about 5 nm to about 30 nm, about 10 nm to about 30 nm, about 20 nm to about 30 nm, about 10 nm to about 20 nm, or about 15 nm to about 25 nm.

The metal fluoride nanostructures may be arranged on an outer surface of the electrically conductive nanostructured material. For example, in embodiments where carbon nanotubes or hollow carbon nanofibers are used, the metal fluoride nanostructures may only be arranged on the outer surface or ablumen of the carbon nanotubes or nanofibers, and not be present in the inner surface or lumen of the carbon nanotubes or nanofibers.

The metal fluoride nanostructures may be present in an amount in the range of about 5 wt % to about 90 wt % of the nanocomposite. For example, the metal fluoride nanostructures may be present in an amount in the range of about 10 wt % to about 80 wt %, about 25 wt % to about 80 wt %, about 40 wt % to about 80 wt %, about 60 wt % to about 80 wt %, about 5 wt % to about 60 wt %, about 5 wt % to about 40 wt %, about 5 wt % to about 30 wt %, about 25 wt % to about 65 wt %, or about 40 wt % to about 60 wt %.

As mentioned above, the nanocomposite materials disclosed herein have demonstrated outstanding electrochemical performances in lithium primary (disposal) and secondary (rechargeable) cells, with at least two times higher capacity than other fluorinated metal materials and metal oxide materials.

Various embodiments refer accordingly in a second aspect to an electrode comprising a nanocomposite according to the first aspect.

The term “electrode” may refer to a “cathode” or an “anode”. The terms “cathode” and “positive electrode” are used interchangeably, and refer to the electrode having the higher of electrode potential in an electrochemical cell (i.e. higher than the negative electrode). Conversely, the terms “anode” and “negative electrode”, which are used interchangeably, refer to the electrode having the lower of electrode potential in an electrochemical cell (i.e. lower than the positive electrode). Cathodic reduction refers to a gain of electron(s) of a chemical species, and anodic oxidation refers to a loss of electron(s) of a chemical species.

The terms “charge” and “charging” refer to process of increasing electrochemical potential energy of an electrochemical cell, which may take place by replacement of or addition of depleted active electrochemical materials with new active compounds. The term “electrical charging” refers to process of increasing electrochemical potential energy of an electrochemical cell by providing electrical energy to the electrochemical cell.

“Electrode potential” refers to a voltage, usually measured against a reference electrode, due to the presence within or in contact with the electrode of chemical species at different oxidation (valence) states.

The term “electrochemical cell” or “cell” refers to a device that converts chemical energy into electrical energy, or electrical energy into chemical energy. Generally, electrochemical cells have two or more electrodes and an electrolyte, wherein electrode reactions occurring at the electrode surfaces result in charge transfer processes. The term “electrolyte” refers to an ionic conductor which may be in a solid state, including in a gel form, or a liquid state. Generally, electrolytes are present in the liquid state. Examples of electrochemical cells include, but are not limited to, batteries and electrolysis systems.

As disclosed herein, the nanocomposite comprises an electrically conductive nanostructured material; and metal fluoride nanostructures having the general formula M^{(I)}ₓM^{(II)}₁₋ₓF_{2+y-zn} arranged on the electrically conductive nanostructured material, wherein M^{(I)} and M^{(II)} are independently transition metals, n is a stoichiometric coefficient, and wherein i) x=0, 0<y≦2, and z=0; or ii) 0<x<1, 0≦y≦2, z≧0, and M^{(I)} and M^{(II)} are different transition metals. Examples of electrically conductive nanostructured material and metal fluoride nanostructures have already been provided above.

In various embodiments, the electrically conductive nanostructured material is selected from the group consisting of carbon nanotubes, carbon nanofibers, and mixtures thereof.

Amount of the electrically conductive nanostructured material in the electrode may be in the range of about 20 wt % to about 45 wt %. For example, amount of the electrically conductive nanostructured material may be in the range of about 25 wt % to about 45 wt %, about 30 wt % to about 45 wt %, about 35 wt % to about 45 wt %, about 40 wt % to about 45 wt %, about 20 wt % to about 40 wt %, about 20 wt % to about 35 wt %, about 20 wt % to about 30 wt %, about 25 wt % to about 40 wt %, or about 30 wt % to about 40 wt %.

The metal fluoride nanostructures may comprise an outer layer of carbon. When present, amount of carbon in the electrode may be in the range of about 20 wt % to about 45 wt %, such as about 25 wt % to about 45 wt %, about 30 wt % to about 45 wt %, about 35 wt % to about 45 wt %, about 40 wt % to about 45 wt %, about 20 wt % to about 40 wt %, about 20 wt % to about 35 wt %, about 20 wt % to about 30 wt %, about 25 wt % to about 40 wt %, or about 30 wt % to about 40 wt %.

The electrode may further comprise a binder. As used herein, the term “binder” refers to a substance that is capable of holding or attaching two or more materials together. A binder may be used in the electrode to hold the nanocomposite together. In various embodiments, the binder is selected from the group consisting of polyvinylidene fluoride (PVDF), polyacrylonitrile, poly(acrylic acid), poly(vinylidene fluoride-co-hexafluoropropylene), copolymers thereof, and mixtures thereof.

In various embodiments, the binder comprises or consists of polyvinylidene fluoride. Advantageously, polyvinylidene fluoride provides good binding properties as well as good electrochemical stability.

Amount of binder in the electrode may be in the range of about 10 wt % to about 20 wt %, such as about 12 wt % to about 20 wt %, about 15 wt % to about 20 wt %, about 18 wt % to about 20 wt %, about 10 wt % to about 18 wt %, about 10 wt % to about 15 wt %, about 10 wt % to about 12 wt %, about 12 wt % to about 18 wt %, or about 14 wt % to about 16 wt %.

The electrode may be a cathode of a lithium battery. It will be understood that the terms “battery” and “cell” may be used interchangeable herein. A “battery” may consist of a single cell or of cells arrangement in series and in parallel to form a battery module or a battery pack. For the purposes of illustration and brevity, it is also to be understood that while present disclosure has been described in detail with respect to lithium batteries, the scope of the invention is not limited as such.

Various embodiments refer in a third aspect to a method of preparing a nanocomposite according to the first aspect. The method comprises providing metal fluoride nanostructures having the general formula M^{(I)}ₓM^{(II)}₁₋ₓF_{2+y-zn}, wherein M^{(I)} and M^{(II)} are independently transition metals, n is a stoichiometric coefficient, and wherein i) x=0, 0<y≦2, and z=0; or ii) 0<x<1, 0≦y≦2, z≧0, and M^{(I)} and M^{(II)} are different transition metals; and arranging the metal fluoride nanostructures on an electrically conductive nanostructured material to obtain the nanocomposite.

Examples of metal fluoride nanostructures and electrically conductive nanostructured material have already been discussed above.

In various embodiments, providing the metal fluoride nanostructures comprises fluorinating a metal salt with fluorine gas and/or a fluorination agent. Examples of fluorination agent include ammonium fluoride, hydrogen fluoride, ammonium bifluoride, fluorine, potassium fluoride, sodium fluoride, cesium fluoride, tetramethylammonium fluoride, tetra-n-butylammonium fluoride, and/or trifluoroacetic acid.

For example, fluorinating the metal salt with fluorine gas and/or a fluorination agent is carried out by thermogravimetric means in a fluorine gas environment and/or in presence of a fluorination agent. For example, the metal salt may be fluorinated by heating at a temperature in the range of about 400° C. to about 450° C. in a fluorine gas environment and/or in the presence of a fluorination agent.

Temperature and time duration for fluorinating the metal salt with fluorine gas and/or a fluorination agent may vary depending on, for example, whether a fluorine gas and/or fluorination agent is used, and the type of fluorination agent used.

In some embodiments, fluorinating the metal salt with fluorine gas and/or a fluorination agent is carried out at a temperature in the range of about 15° C. to about 600° C. For example, fluorinating the metal salt with fluorine gas and/or a fluorination agent may be carried out at a temperature in the range of about 50° C. to about 600° C., such as about 100° C. to about 600° C., about 150° C. to about 600° C., about 200° C. to about 600° C., about 300° C. to about 600° C., about 450° C. to about 600° C., about 15° C. to about 500° C., about 15° C. to about 400° C., about 15° C. to about 300° C., about 15° C. to about 200° C., about 15° C. to about 100° C., about 15° C. to about 40° C., or about 25° C. to about 80° C. Advantageously, fluorinating of the metal salt with fluorine gas and/or a fluorination agent may be carried out at ambient temperature, and energy or heat input is not required.

Fluorinating the metal salt with fluorine gas and/or a fluorination agent may be carried out for a time period of about 120 hours or less. In various embodiments, fluorinating the metal salt with fluorine gas and/or a fluorination agent is carried out for a time period of about 100 hours or less, about 80 hours or less, about 60 hours or less, about 48 hours or less, about 36 hours or less, about 24 hours or less, about 12 hours or less, or about 6 hours or less. In specific embodiments, fluorinating the metal salt with fluorine gas and/or a fluorination agent is carried out for a time period of about 72 hours or less.

Providing the metal fluoride nanostructures may further include chemically reducing the metal fluoride nanostructures. In various embodiments, chemically reducing the metal fluoride nanostructures is carried out using a reducing agent selected from the group consisting of alkali metals, alkali earth metals, lanthanides, hydrogen, hydrazine, ammonia, amines, and combinations thereof. In some embodiments, chemically reducing the metal fluoride nanostructures is carried out using a reducing agent selected from the group consisting of Li-naphtalenide, Na-naphtalenide, Li-biphenyl, Na-biphenyl, butyl-lithium, butyl-sodium, and combinations thereof. Chemical reduction of the metal fluoride nanostructures may be used as a means to pre-lithiate or pre-sodiate the metal fluoride nanostructures. In some instances, chemical reduction of the metal fluoride nanostructures serves to insert ions of other metals, different from the metal of the metal fluoride, into the metal fluoride crystal for alternative ions battery.

Providing the metal fluoride nanostructures may include adding a carbon precursor to metal fluoride nanostructures to form a mixture; and calcining the mixture in an inert environment to form an outer layer of carbon on the metal fluoride nanostructures. In various embodiments, the carbon precursor is selected from the group consisting of sucrose, oleic acid, propanol, polyethylene glycol, glucose, octane, and mixtures thereof.

Calcining the mixture in an inert environment to form an outer layer of carbon on the metal fluoride nanostructures may be carried out for a suitable time and at a temperature sufficient to form the outer layer of carbon. The inert environment may be one that contains an inert gas such as argon and/or helium.

In various embodiments, calcining the mixture in an inert environment is carried out at a temperature in the range of about 180° C. to about 300° C., such as about 200° C. to about 300° C., about 250° C. to about 300° C., about 180° C. to about 250° C., or about 200° C. to about 350° C.

In various embodiments, providing the metal fluoride nanostructures may include adding the metal fluoride nanostructures to a carbon material such as carbon black to form a mixture, and physically or mechanically working the mixture, such as by ball milling, in an inert environment to form an outer layer of carbon on the metal fluoride nanostructures.

The metal fluoride nanostructures may be arranged on an electrically conductive nanostructured material to obtain the nanocomposite. Prior to arranging the metal fluoride structures on the electrically conductive nanostructured material, the electrically conductive nanostructured material may be functionalized. For example, electrically conductive nanostructured material of carbon nanotubes may be functionalized by reacting them with an acid, such as nitric acid and/or sulfuric acid, which may be carried out at a temperature up to about 80° C. and for a time period in the range of between about 8 hours to about 24 hours.

Arranging the metal fluoride nanostructures on an electrically conductive nanostructured material may include forming the metal fluoride nanostructures in the presence of the electrically conductive nanostructured material and depositing the metal fluoride nanostructures on the electrically conductive nanostructured material.

In various embodiments, the electrically conductive nanostructured material is dispersed in a solvent to fill an interior volume of the electrically conductive nanostructured material with the solvent prior to arranging the metal fluoride nanostructures on the electrically conductive nanostructured material.

As mentioned above, the electrically conductive nanostructured material comprised in the nanocomposite may be selected from the group consisting of carbon nanotubes, carbon nanofibers, and mixtures thereof. In dispersing the electrically conductive nanostructured material such as carbon nanotubes and/or hollow carbon nanofibers in a solvent, an interior volume or lumen of the electrically conductive nanostructured material may be filled with the solvent, which may be subsequently removed after the metal fluoride nanostructures have been arranged on the electrically conductive nanostructured material. By forming the metal fluoride nanostructures in the presence of the solvent-filled electrically conductive nanostructured material, the metal fluoride nanostructures may be arranged only on an outer surface of the electrically conductive nanostructured material, such as ablumen of carbon nanotubes and/or hollow carbon nanofibers.

In various embodiments, the solvent comprises or consists of a C₆-C₁₀ alkane, which may be linear or branched. Examples of suitable solvents include hexane, heptane, octane, nonane, and decane. In specific embodiments, the solvent comprises or consists of octane.

In a further aspect, use of a nanocomposite according to the first aspect in an electrochemical cell, a symmetric supercapacitor, an asymmetric supercapacitor, a primary battery, or a rechargeable battery is provided.

In various embodiments, the nanocomposite is comprised in an electrode for use in a symmetric supercapacitor and/or an asymmetric supercapacitor. Advantageously, the inherently high surface area of the nanocomposite renders its suitability for use as an electrode material in a symmetric supercapacitor and/or an asymmetric supercapacitor.

The nanocomposite may also be comprised in an electrode for use in a primary battery, including but not limited to, a primary lithium battery. For example, the electrode comprising the nanocomposite may be used in a 1.5V battery compatible with alkaline batteries of similar voltage, and opposed to 3V primary batteries such as Li/MnO₂ and Li/CFₓ cells.

In addition to the above, the nanocomposite may be comprised in an electrode for use in a secondary battery, otherwise termed herein as a rechargeable battery. For example, the nanocomposite may be used to form a cathode in the rechargeable battery. Alternatively, the nanocomposite may be used to form an anode in the rechargeable battery, for use against a high voltage cathode such as 5V cathodes or lithium manganese nickel oxide (LMNO) spinel cathodes, for example.

Hereinafter, the present invention will be described more fully with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, lengths and sizes of layers and regions may be exaggerated for clarity.

As used herein, the term “and/or” includes any and all combinations of one or more of the associated listed items. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXPERIMENTAL SECTION

### Example 1

### Preparation of MFₙ, Carbon Coated MFₙ, and Their Characterization

1.1 Preparation of MFₙ

Metal nitrates were dissolved in ethanol. Ammonium fluoride solution was added in drop by drop, and the mixture was stirred for 2 hours. The materials obtained were washed and centrifuged with ethanol 3 times. The materials were then dried at 80° C. overnight, and calcined at 400° C. in argon gas for 2 hours at a flow rate of 150 ml/min to form MFₙ.

1.2 Preparation of Carbon Coated MFₙ

Metal nitrates were dissolved in ethanol to form, a metal nitrate solution. A carbon precursor such as sucrose, oleic acid, propanol, polyethylene glycol, octane, or glucose was added to the metal nitrate solution. Ammonium fluoride solution was added in drop by drop, and the mixture was stirred for 2 hours. The materials obtained were washed and centrifuged with ethanol 3 times. The materials were then dried at 80° C. overnight, and calcined at 400° C. in argon gas for 2 hours at a flow rate of 150 ml/min to form carbon coated MFₙ.

1.3 Characterization of MFₙ and Carbon Coated MFₙ

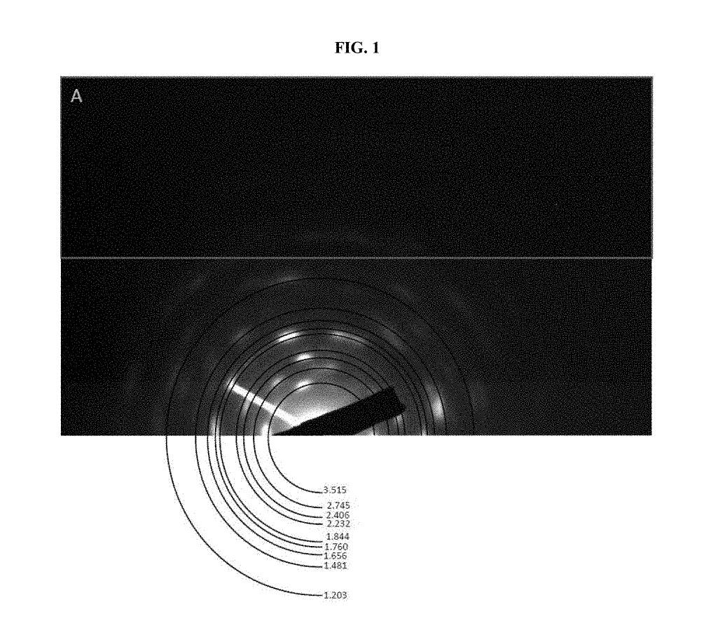

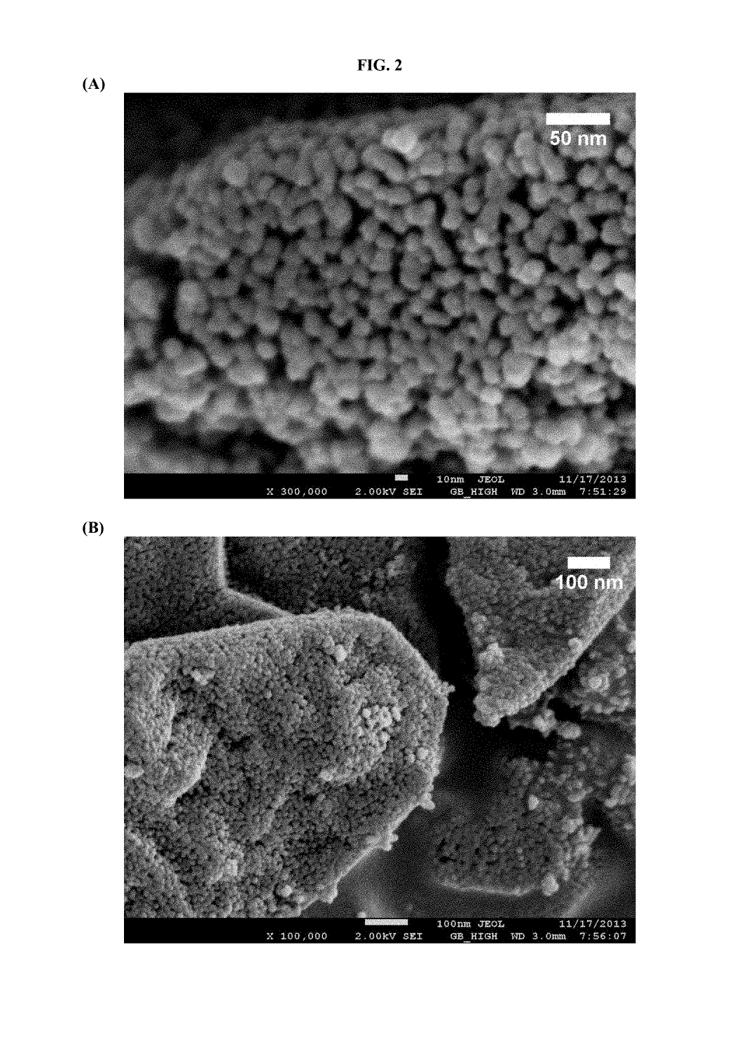

FIG. 1 shows transmission electron microscopy (TEM) characterization of NiF₂, where (A) is the SAED image taken for as synthesized NiF₂. The respective d-spacings (as measured in the SAED image) are listed in Å.

FIG. 2 shows field emission scanning electron microscopy (FESEM) characterization of NiF₂, where (A) is the FESEM image for as synthesized NiF₂ at 300 K magnification; and (B) is the FESEM image for as synthesized NiF₂ at 150 K magnification.

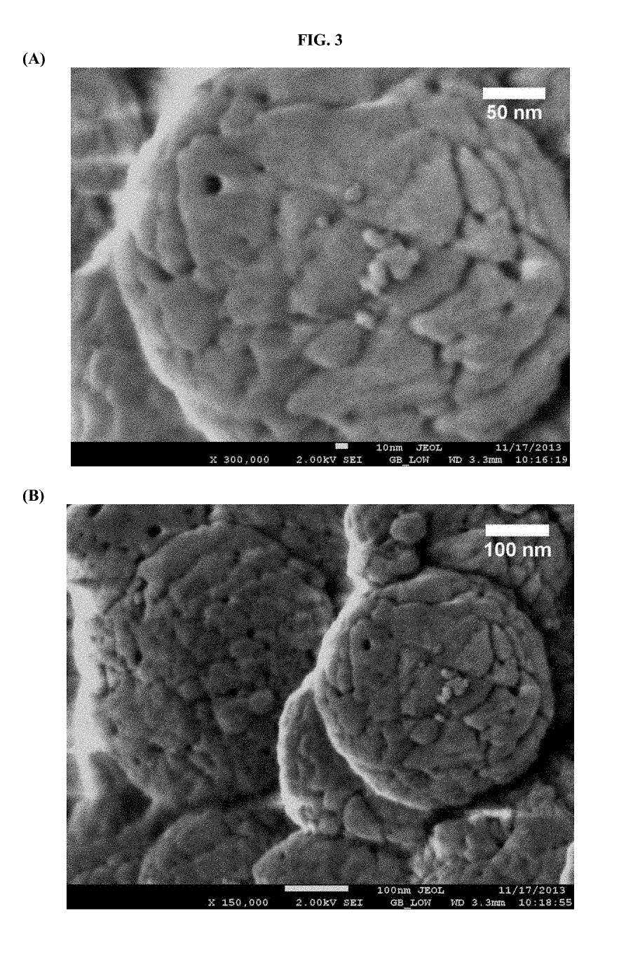

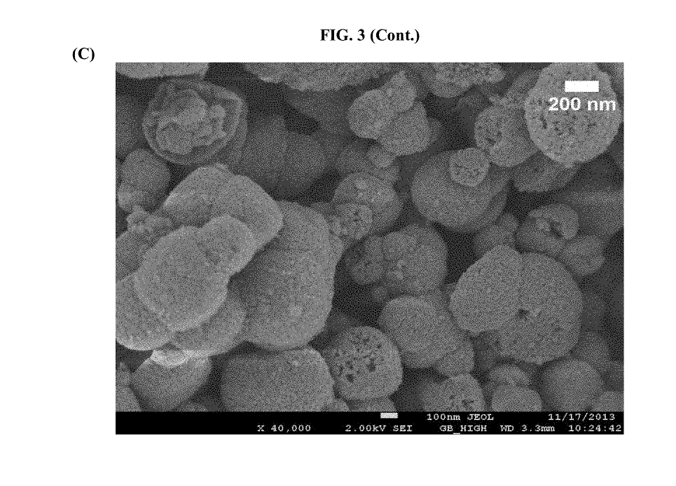

FIG. 3 shows FESEM characterization of CoF₂, where (A) is the FESEM image for as synthesized CoF₂ at 300 K magnification; (B) is the FESEM image for as synthesized CoF₂ at 150 K magnification; and (C) is the FESEM image for as synthesized CoF₂ at 40 K magnification.

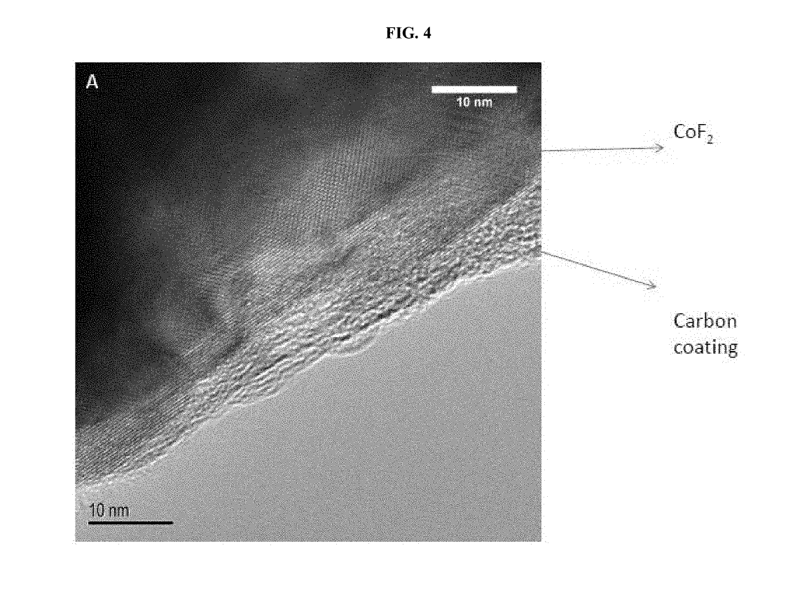

FIG. 4 shows TEM characterization of CoF₂, where (A) is the high resolution transmission electron microscopy (HRTEM) image for as synthesized carbon coated CoF₂. Measured d-spacing is 0.336 nm, which coincides with d-spacing of (110).

### Example 2

### Preparation of Carbon Coated M^{(I)}ₓM^{(II)}₍₁₋ₓ₎F₂ (0≦x≦1) and Characterization

2.1 Preparation of Carbon Coated M^{(I)}ₓM^{(II)}₍₁₋ₓ₎F₂ (0≦x≦1)

Nitrates of two different metals M^{(I)} and M^{(II)} were dissolved in ethanol to form a nitrate solution. A carbon precursor, such as sucrose, oleic acid, propanol, polyethylene glycol, octane, or glucose, was added to the metal nitrate solution. Ammonium fluoride solution was added in drop by drop, and the mixture was stirred for 2 hours. The materials obtained were washed and centrifuged with ethanol 3 times. The materials were then dried at 80° C. overnight, and calcined at 400° C. in argon gas for 2 hours at a flow rate of 150 ml/min to form the carbon coated M^{(I)}ₓM^{(II)}₍₁₋ₓ₎F₂, 0≦x≦1.

2.2 Characterization of M^{(I)}ₓM^{(II)}₍₁₋ₓ₎F₂, 0≦x≦1

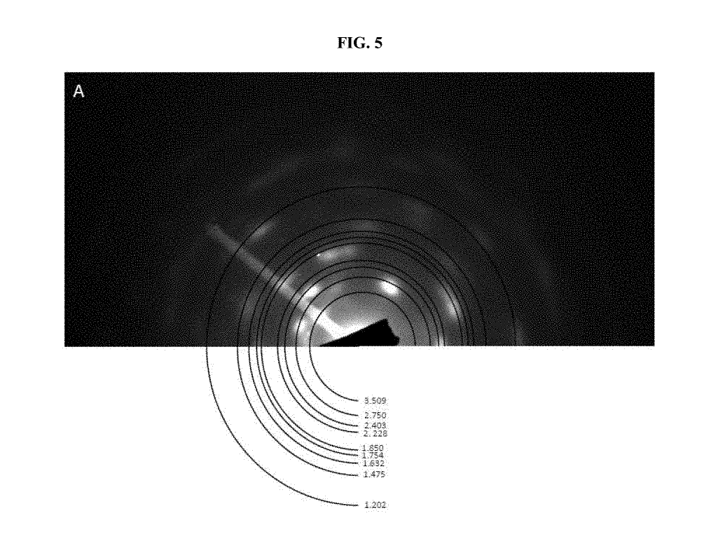

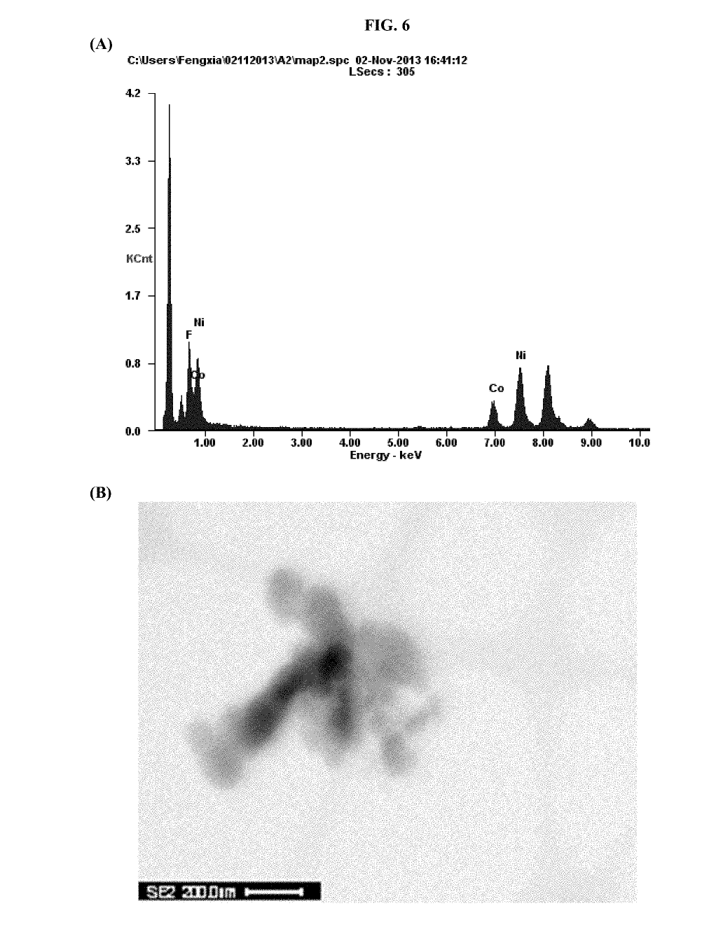

FIG. 5 shows TEM characterization of Ni_{0.75}Co_{0.25}F₂, where (A) is the SAED image taken for as synthesized Ni_{0.75}Co_{0.25}F₂. The respective d-spacings (as measured in the SAED image) are listed in Å.

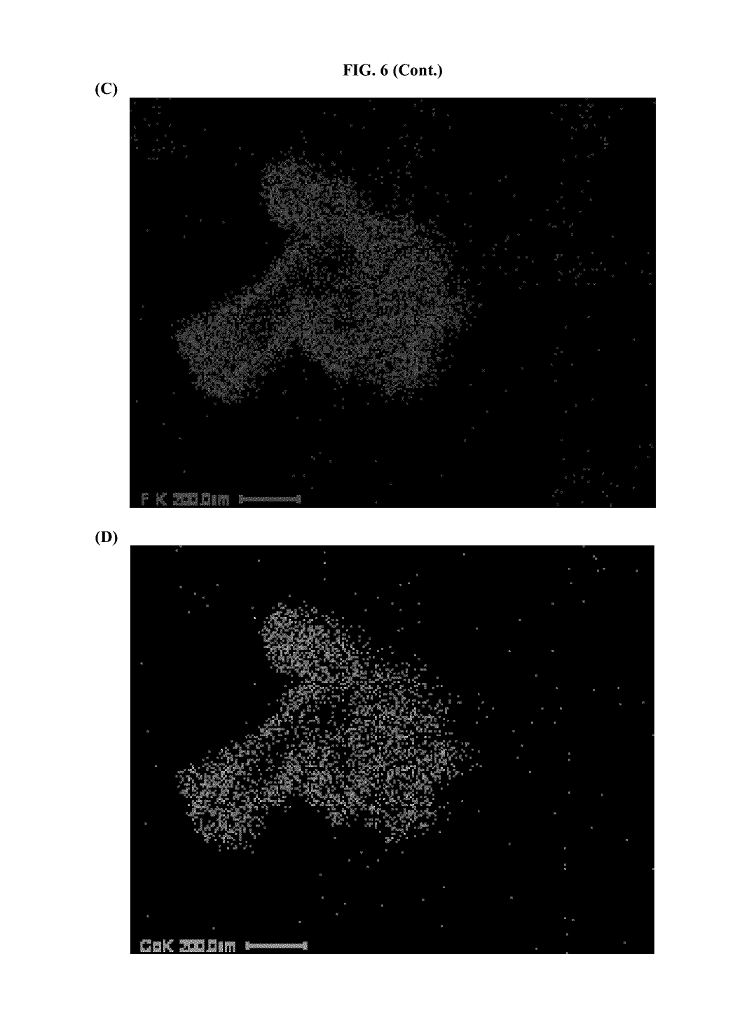

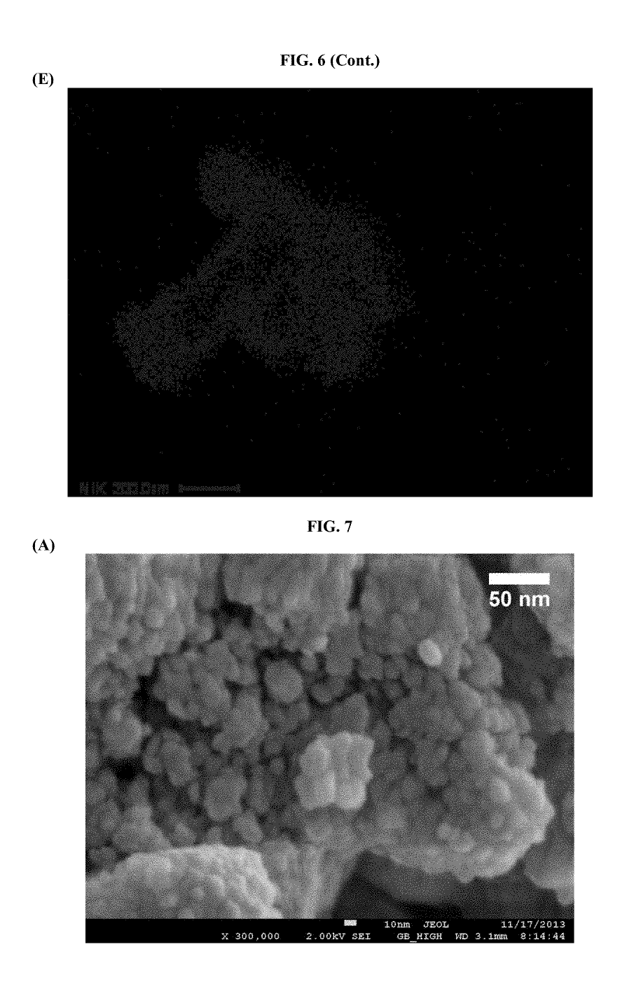

FIG. 6 shows transmission electron microscopy-energy-dispersive X-ray spectroscopy (TEM-EDX) mapping of Ni_{0.75}Co_{0.25}F₂, where (A) is the EDX spectrum obtained in the TEM; (B) is the secondary electron image obtained in the TEM; (C) is the fluorine element map; (D) is the cobalt element map; and (E) is the nickel element map.

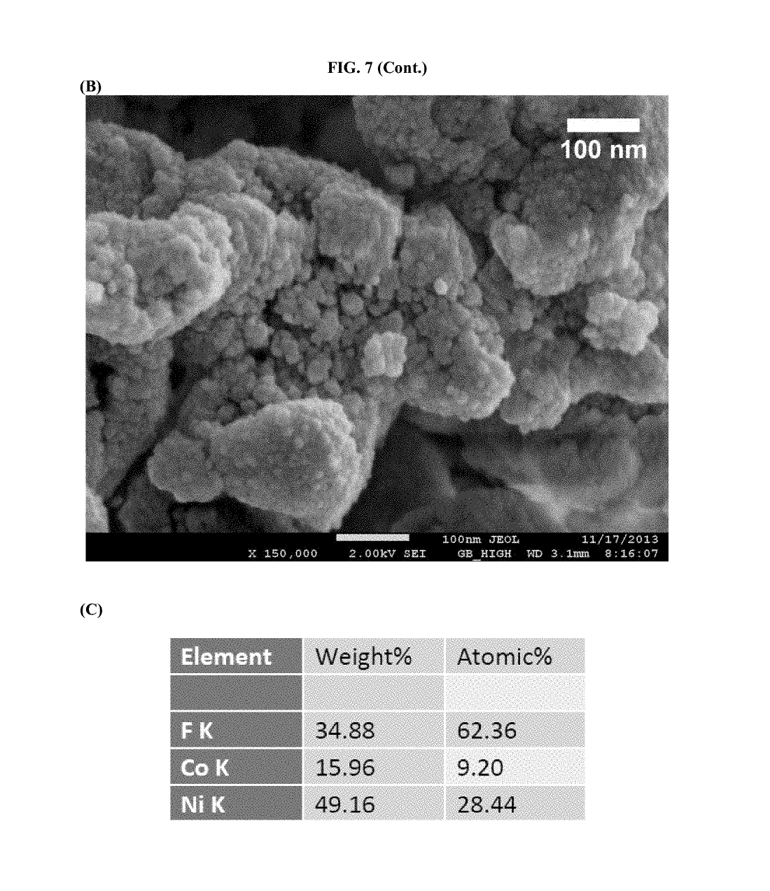

FIG. 7 shows SEM characterization of Ni_{0.75}Co_{0.25}F₂, where (A) is the FESEM image for as synthesized Ni_{0.75}Co_{0.25}F₂ at 300 K magnification; (B) is the FESEM image for as synthesized Ni_{0.75}Co_{0.25}F₂ at 150 K magnification; and (C) is a table showing weight % and atomic % of F, Co and Ni.

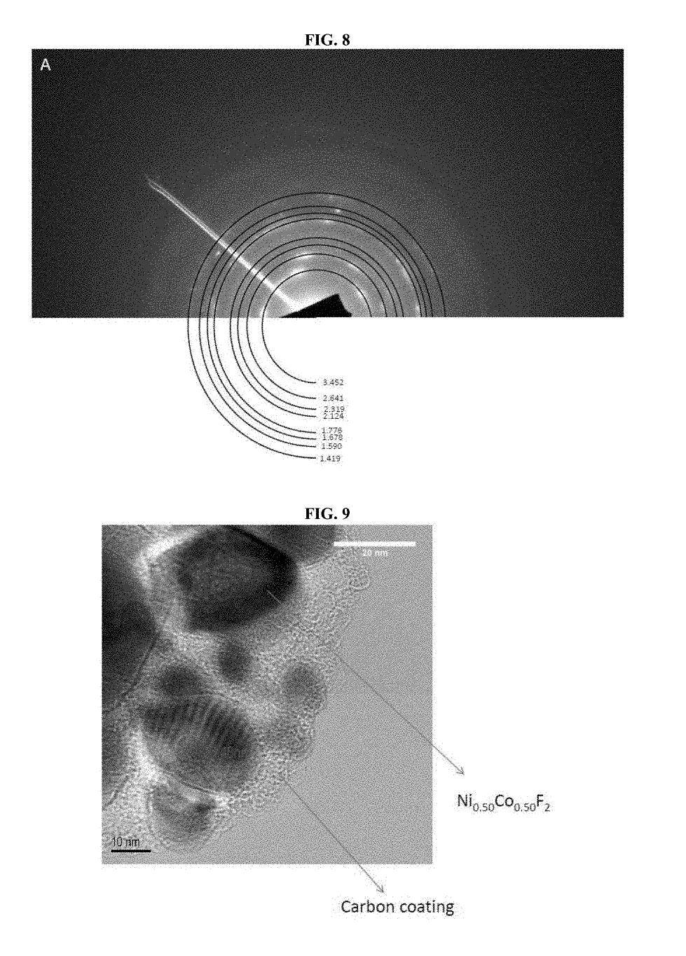

FIG. 8 shows TEM characterization of Ni_{0.5}Co_{0.5}F₂, where (A) is the SAED image taken for as synthesized Ni_{0.5}Co_{0.5}F₂. The respective d-spacings (as measured in the SAED image) are listed in Å.

FIG. 9 shows TEM image for as synthesized carbon coated Ni_{0.5}Co_{0.5}F₂.

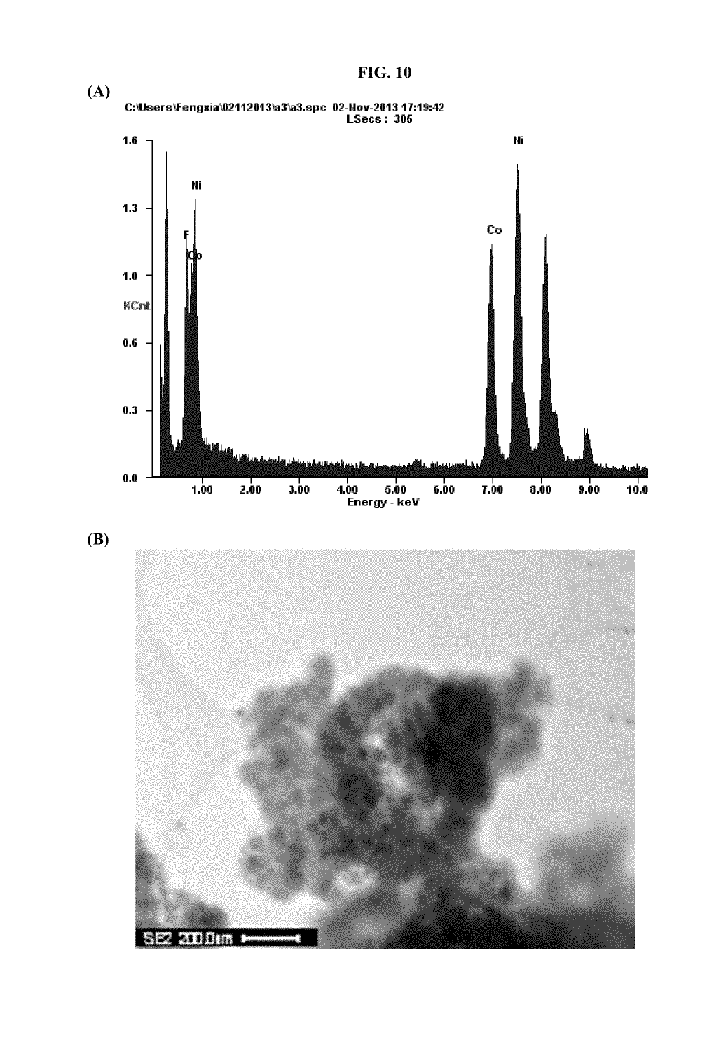

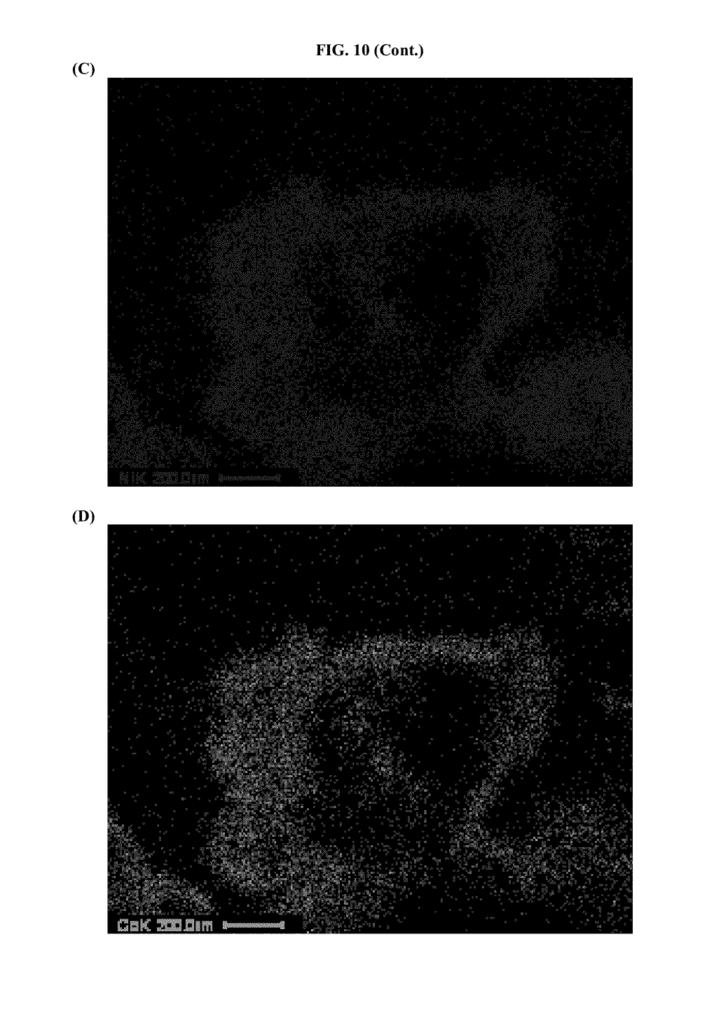

FIG. 10 shows transmission electron microscopy-energy-dispersive X-ray spectroscopy (TEM-EDX) mapping of Ni_{0.5}Co_{0.5}F₂, where (A) is the EDX spectrum obtained in the TEM; (B) is the secondary electron image obtained in the TEM; (C) is the nickel element map; (D) is the cobalt element map; and (E) is the fluorine element map.

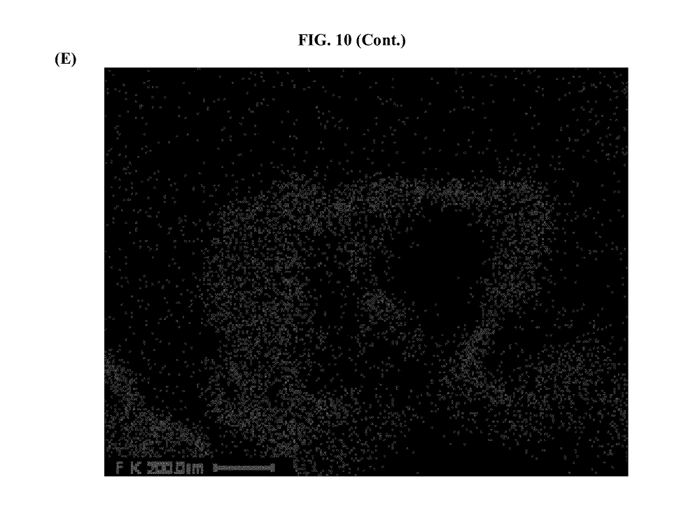

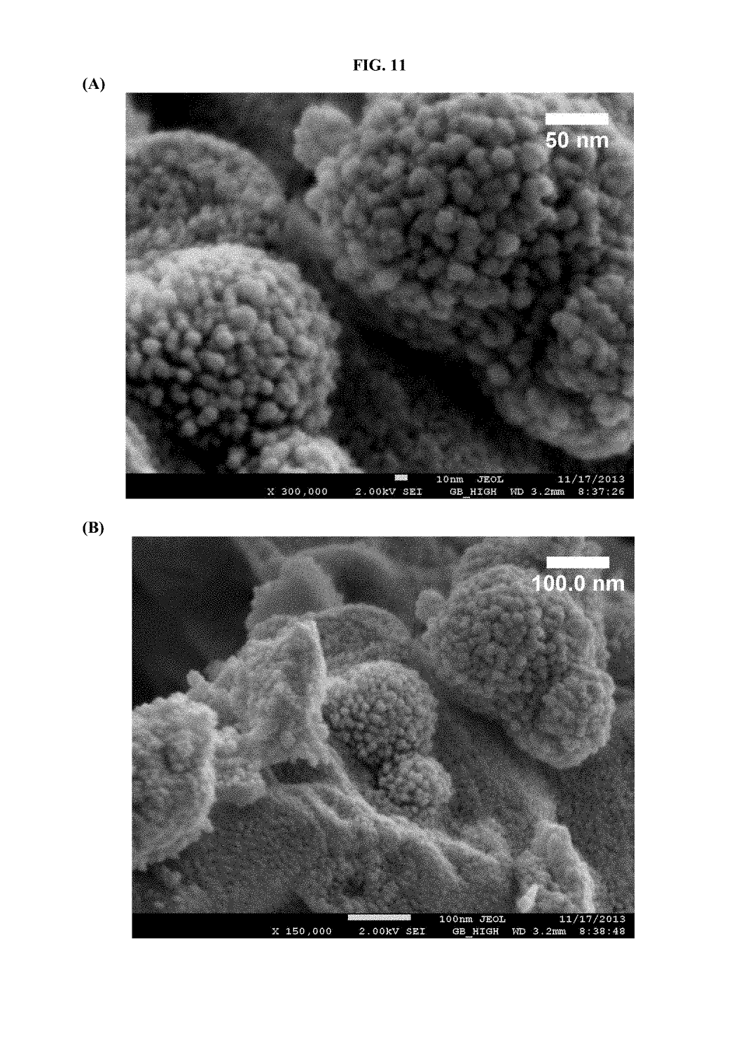

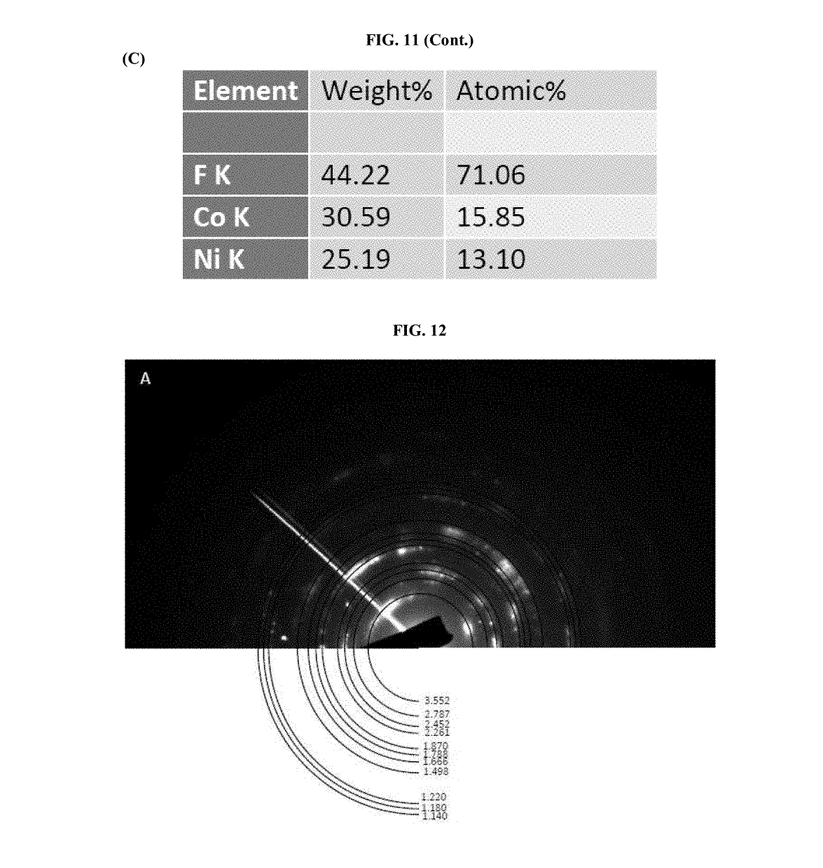

FIG. 11 shows SEM characterization of Ni_{0.5}Co_{0.5}F₂, where (A) is the FESEM image for as synthesized Ni_{0.5}Co_{0.5}F₂ at 300 K magnification; (B) is the FESEM image for as synthesized Ni_{0.5}Co_{0.5}F₂ at 150 K magnification; and (C) is a table showing weight % and atomic % of F, Co and Ni.

FIG. 12 shows TEM characterization of Ni_{0.25}Co_{0.75}F₂, where (A) is the SAED image taken for as synthesized Ni_{0.25}Co_{0.75}F₂. The respective d-spacings (as measured in the SAED image) are listed in Å.

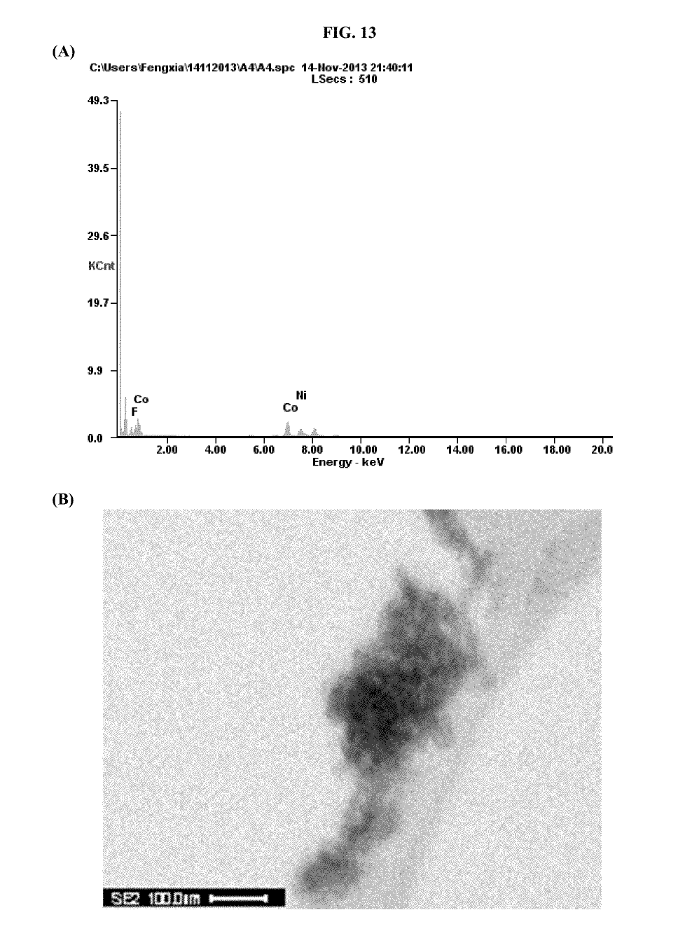

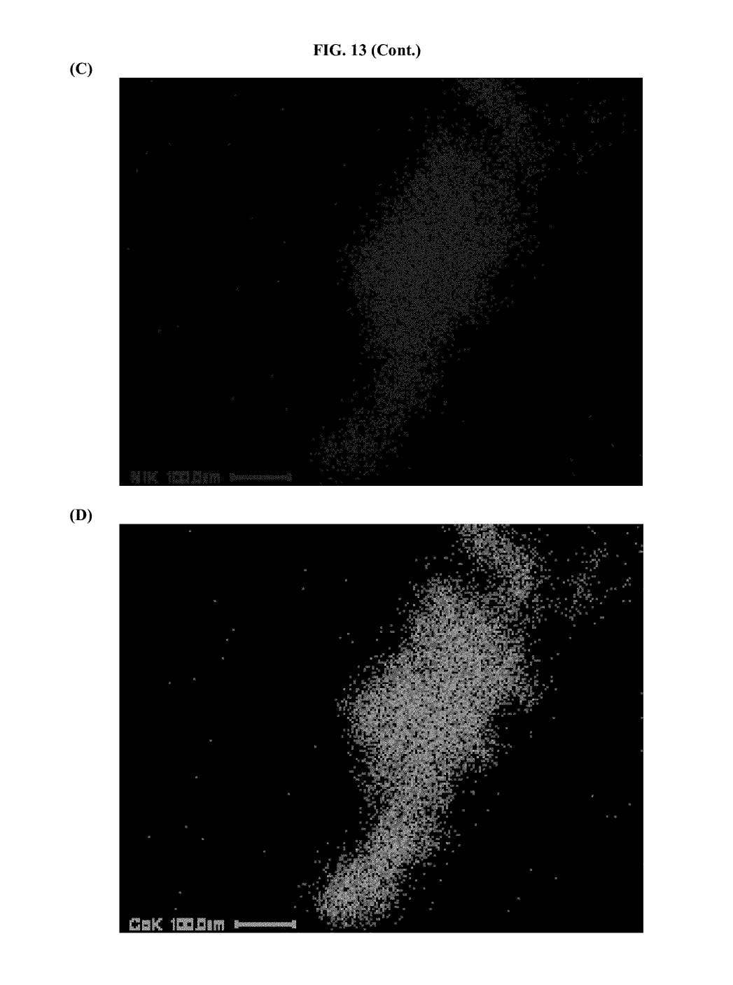

FIG. 13 shows transmission electron microscopy-energy-dispersive X-ray spectroscopy (TEM-EDX) mapping of Ni_{0.25}Co_{0.75}F₂, where (A) is the EDX spectrum obtained in the TEM; (B) is the secondary electron image obtained in the TEM; (C) is the nickel element map; (D) is the cobalt element map; and (E) is the fluorine element map.

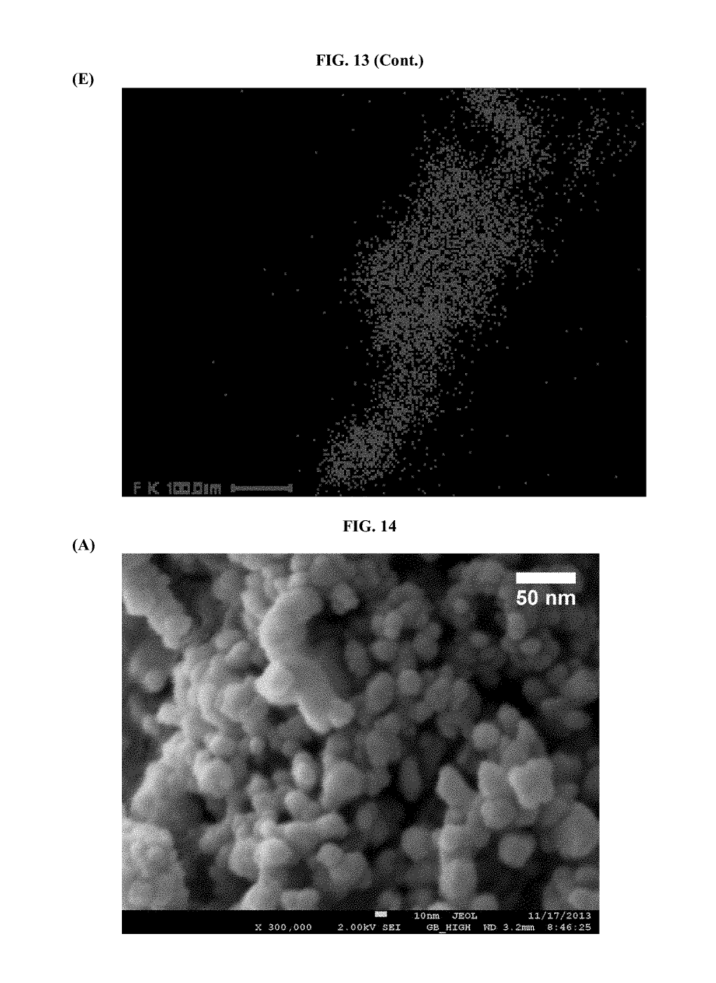

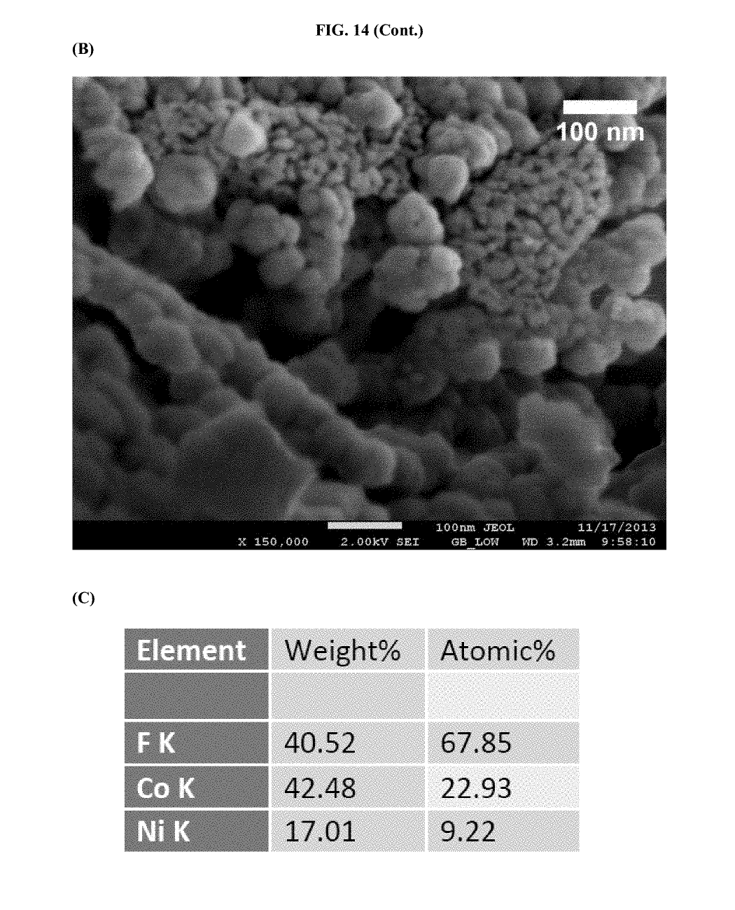

FIG. 14 shows SEM images of Ni_{0.25}Co_{0.75}F₂, where (A) is the FESEM image for as synthesized Ni_{0.25}Co_{0.75}F₂ at 300 K magnification; (B) is the FESEM image for as synthesized Ni_{0.25}Co_{0.75}F₂ at 150 K magnification; and (C) is a table showing weight % and atomic % of F, Co and Ni.

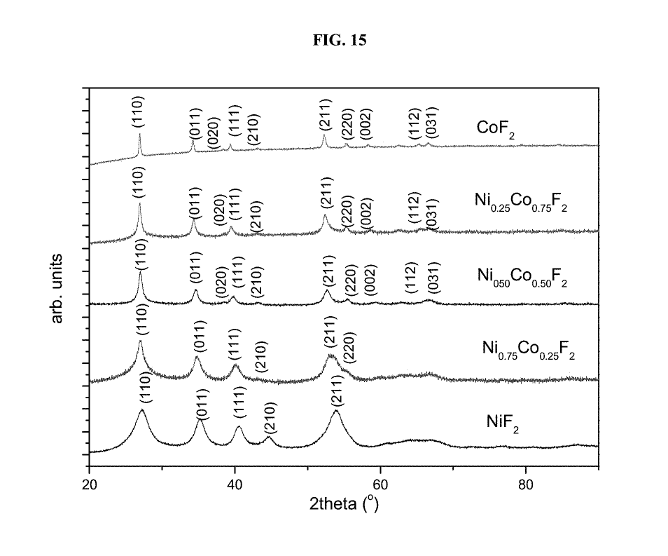

FIG. 15 is a X-ray diffraction (XRD) chart for CoF₂, Ni_{0.25}Co_{0.75}F₂, Ni_{0.5}Co_{0.5}F₂, Ni_{0.75}Co_{0.25}F₂, and NiF₂.

### Example 3

### Preparation of Carbon Coated MF₂ Grown on Carbon Nanotubes or Carbon Nanofibers

Carbon nanotubes (CNT) (nc3100) or carbon nanofibers (CNF) (PR24 LHT) were functionalized by boiling them in acids, such as nitric acid and/or sulphuric acid, at 800° C. for 8 to 24 hours. The acid-CNT mixture was neutralized, and centrifuged or filtered to obtain the CNT or CNF. The CNT or CNF were dried at 80° C. in an oven overnight, and subsequently dispersed in an appropriate amount of octane. An appropriate amount of ethanol was added. Generally, 100 mg of CNT or CNF requires about 50 ml of octane and 50 ml of ethanol.

Metal nitrates were dissolved in ethanol to form a metal nitrate solution. A carbon precursor such as sucrose, oleic acid, propanol, polyethylene glycol, glucose, and octane was added to the metal nitrate solution. Ammonium fluoride solution was added in drop by drop, and the mixture was stirred for 2 hours. The materials obtained were washed and centrifuged with ethanol 3 times. The materials were then dried at 80° C. overnight, and calcined at 400° C. in argon gas for 2 hours at a flow rate of 150 ml/min to form carbon coated MF₂ grown on carbon nanotubes or carbon nanofibers.

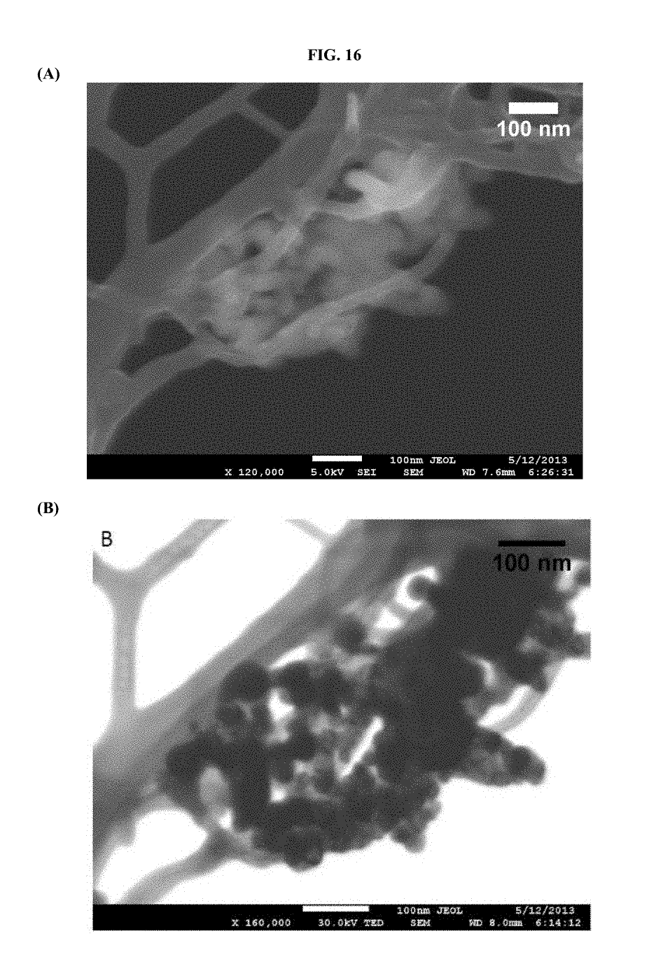

FIG. 16 depicts CoF₂ grown on nc3100 (CNT), where (A) is the FESEM image for CoF₂ grown on nc3100 at 120 K magnification; and (B) is the transmission electron detector (TED) image for CoF₂ grown on nc3100 at 160 K magnification. CoF₂ was grown on nc3100 to improve electronic conductivity as CoF₂ is electronically insulating.

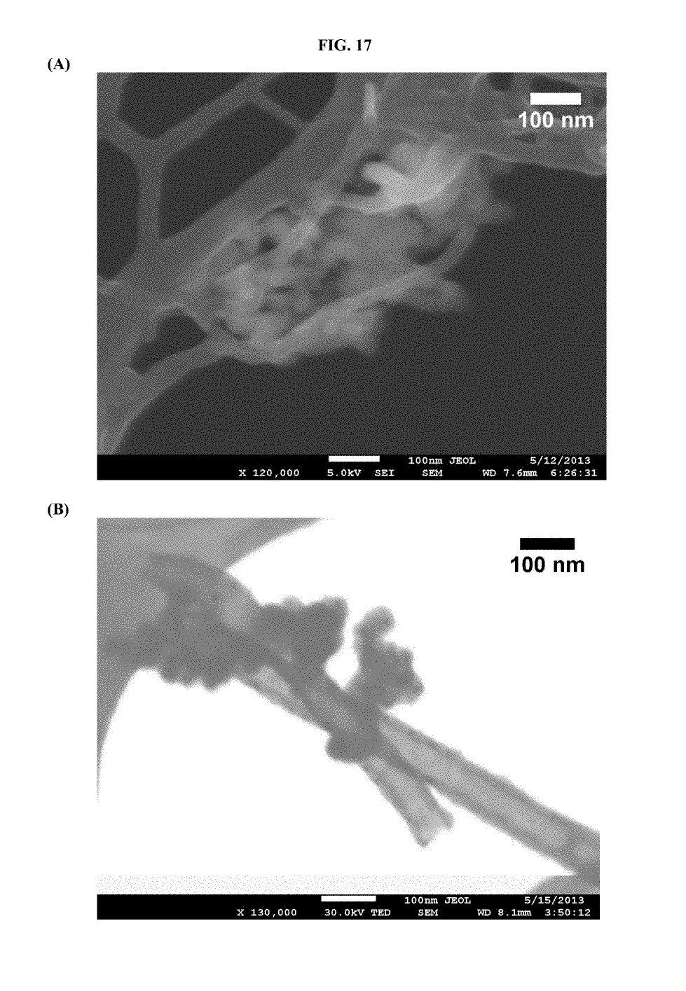

FIG. 17 depicts CoF₂ grown on PR24 LHT (CNF), where (A) is the FESEM image for CoF₂ grown on PR24 LHT at 120 K magnification; and (B) is the TED image for CoF₂ grown on PR24 LHT at 130 K magnification. CoF₂ was grown on PR24 LHT to improve electronic conductivity since CoF₂ is electronically insulating.

### Example 4

### Preparation of Non-Carbon Coated MF_{2+y}, 0≦y≦2

MF_{2+y} was prepared via fluorination by thermogravimetric means in a fluorine gas environment, or by treatment under fluorine gas or a fluorination agent between ambient temperature and 600° C. for up to 120 hours.

TABLE 1
Percent of weight uptake upon fluorination to MF_{2+y} from MF₂

| MF₂ | MF_{2+y} | Percent of Weight uptake from MF₂ | y |
|---|---|---|---|
| NiF₂ | NiF₃ | 19.65% | 1 |
| NiF₂ | NiF₄ | 39.30% | 2 |
| CoF₂ | CoF₃ | 19.60% | 1 |
| CoF₂ | CoF₄ | 39.20% | 2 |

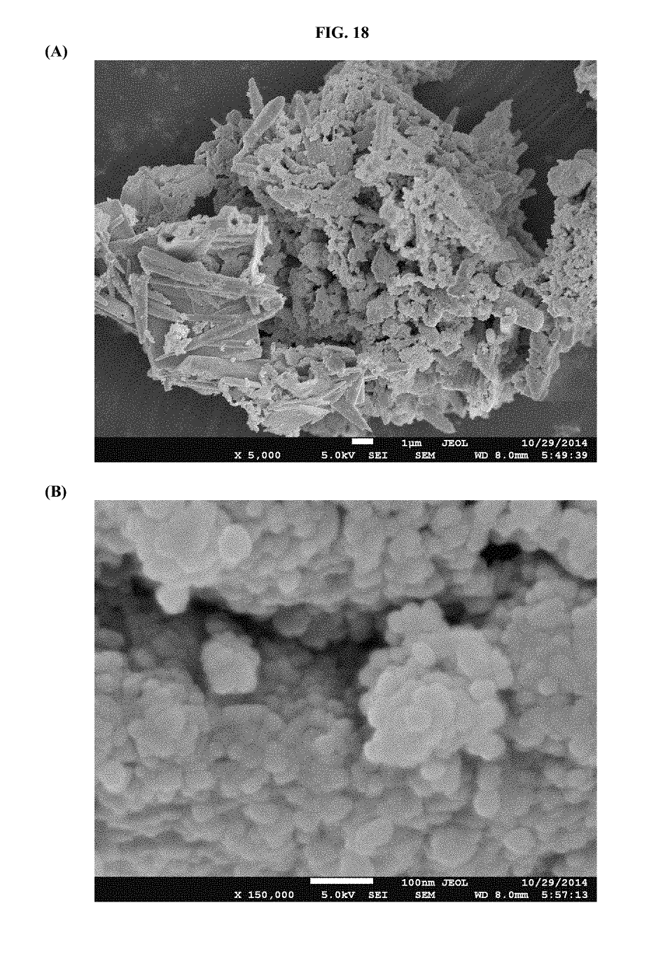

FIG. 18 depicts CoF₃, where (A) is the FESEM image for CoF₃ at 5 K magnification; and (B) is the FESEM image for CoF₃ at 150 K magnification. Particle size of CoF₃ is about 30 nm to 50 nm.

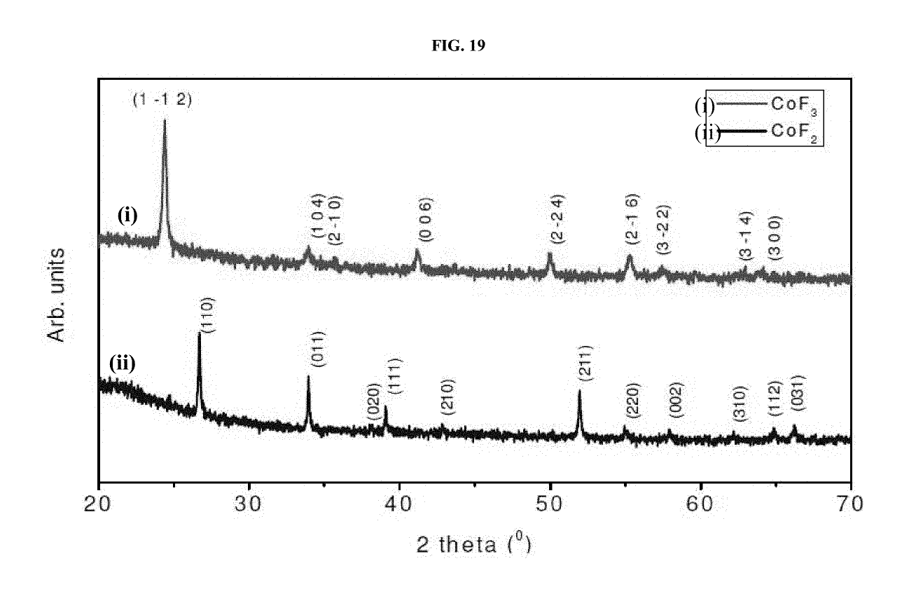

FIG. 19 is a XRD chart of (i) CoF₃, and (ii) CoF₂.

### Example 5

### Preparation of Carbon Coated MF_{2+y}, 0≦y≦2

MF_{2+y} were prepared via fluorination by thermogravimetric means in a fluorine gas environment or by treatment under fluorine gas or a fluorination agent between ambient temperature and 600° C. for up to 120 hours.

Carbon waling was achieved by either dry method or wet method. Dry method involved ball milling MF_{2+y} with carbon black in a helium or argon environment. Wet method involved coating MF_{2+y} with a carbon precursor, such as sucrose, polyethylene glycol, and glucose. Thereafter, the powders were annealed in an argon environment between 180° C. to 300° C.

TABLE 2
Percent of weight uptake upon fluorination to MF_{2+y} from MF₂

| MF₂ | MF_{2+y} | Percent of Weight uptake from MF₂ | y |
|---|---|---|---|
| NiF₂ | NiF₃ | 19.65% | 1 |
| NiF₂ | NiF₄ | 39.30% | 2 |
| CoF₂ | CoF₃ | 19.60% | 1 |
| CoF₂ | CoF₄ | 39.20% | 2 |

### Example 6

### Preparation of Non-Carbon Coated M^{(I)}ₓM^{(II)}₍₁₋ₓ₎F_{2+y}, 0≦x≦1, 0≦y≦2

M^{(I)}ₓM^{(II)}₍₁₋ₓ₎F_{2+y} were prepared via fluorination by thermogravimetric means in a fluorine gas environment or by treatment under fluorine gas or a fluorination agent between ambient temperature and up to 600° C. for up to 120 hours.

TABLE 3
Percent of weight uptake upon fluorination to M^{(I)}ₓM^{(II)}₍₁₋ₓ₎F_{2+y}
from M^{(I)}ₓM^{(II)}₍₁₋ₓ₎F₂

| | | Percent | | |
|---|---|---|---|---|
| | | of Weight uptake from | | |
| M^{(I)}ₓM^{(II)}₍₁₋ₓ₎F₂ | M^{(I)}ₓM^{(II)}₍₁₋ₓ₎ F_{2+y} | MₓM₍₁₋ₓ₎F₂ | x | y |
| Ni_{0.75}Co_{0.25}F₂ | Ni_{0.75}Co_{0.25}F₃ | 19.64% | 0.75 | 1 |
| Ni_{0.75}Co_{0.25}F₂ | Ni_{0.75}Co_{0.25}F₄ | 39.27% | 0.75 | 2 |
| Ni_{0.50}Co_{0.50}F₂ | Ni_{0.50}Co_{0.50}F₃ | 19.62% | 0.50 | 1 |
| Ni_{0.50}Co_{0.50}F₂ | Ni_{0.50}Co_{0.50}F₄ | 39.25% | 0.50 | 2 |
| Ni_{0.25}Co_{0.75}F₂ | Ni_{0.25}Co_{0.75}F₃ | 19.61% | 0.25 | 1 |
| Ni_{0.25}Co_{0.75}F₂ | Ni_{0.25}Co_{0.75}F₄ | 39.22% | 0.25 | 2 |

### Example 7

### Preparation of Carbon Coated M^{(I)}ₓM^{(II)}₍₁₋ₓ₎F_{2+y}, 0≦x≦1, 0≦y≦2

M^{(I)}ₓM^{(II)}₍₁₋ₓ₎F_{2+y} were prepared via fluorination by thermogravimetric means in a fluorine gas environment or by treatment under fluorine gas or a fluorination agent between ambient temperature and up to 600° C. for up to 120 hours.

Carbon coating was achieved by either dry method or wet method. Dry method involves ball milling M^{(I)}ₓM^{(II)}₍₁₋ₓ₎F_{2+y} with carbon black in a helium or argon environment. Wet method involves coating M^{(I)}ₓM^{(II)}₍₁₋ₓ₎F_{2+y} with a carbon precursor such as sucrose, polyethylene glycol, and glucose. Thereafter, the powders were annealed in an argon environment between 180° C. to 300° C.

### Example 8

### Chemical Reduction of M^{(I)}ₓM^{(II)}₍₁₋ₓ₎F_{2+y}, 0≦x≦1, 0≦y≦2

Chemical reduction involved reacting M^{(I)}ₓM^{(II)}₍₁₋ₓ₎F_{2+y} with a reducing chemical R using the following scheme:

M^{(I)}ₓM^{(II)}₍₁₋ₓ₎F_{2+y}+zR→M^{(I)}ₓM^{(II)}₍₁₋ₓ₎F_{2+y-zn}+zRFₙ,

wherein 0≦x≦1, 0≦y≦2, and n=stoichiometric coefficient.

R was based on alkali metals, alkali earth metals, lanthanides, hydrogen, hydrazine, ammonia, and/or amines. Preferred R included Li-naphtalenide, Na-naphtalenide, Li-biphenyl, Na-biphenyl, butyl-lithium, and/or butyl-sodium.

The reduced materials M^{(I)}ₓM^{(II)}₍₁₋ₓ₎F_{2+y-zn} may be used as electrode material in a battery.

### Example 9

### Cell Fabrication of Carbon Coated MF₂

MF₂ was mixed with CNT or CNF. Amount of CNT or CNF added ranged from 20 to 45 weight %. A binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, was added to the carbon and MF₂ mixture. Amount of binder added ranged from 10 to 20%.

Composition of electrode in weight percent was as follows:

| | |
|---|---|
| Active material | 70 to 45% |
| Conductive carbon | 20 to 45% |
| Binder | 10 to 20% |

The electrode was coated onto a current collector. Choice of current collectors included aluminum, titanium, nickel, stainless steel, tantalum, carbon, graphite, and their respective alloys. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Anodes used or which may be used included lithium, carbon, lithium titanate, silicon, tin, and/or antimony.

### Example 10

### Electrochemical Test

MF₂ and M′F_{2+y} materials were used in different types of battery cells, such as

1. A/Electrolyte 1/MF₂

A=alkali metal such as Li, Na, and/or K, and/or alkali-earth metal such as Mg and/or Ca._Electrolyte 1 contained Aⁿ⁺ cations (when n=1, A=alkali metal; when n=2, A=alkaline-earth metal).

2. MF₂/Electrolyte 2/M′F_{2+y}

Electrolyte 2 contained F⁻ anions.

Cell 1: Li/Electrolyte/MF₂

First Operation: Discharge:

$$ε Li \to ε {Li}^{+} + ε {e}^{-} ( anode )$$

$${M F}_{2} + ɛ {Li}^{+} + ɛ {e}^{-} \to ( 1 - \frac{ɛ}{2} ) {M F}_{2} + ɛ LiF + ɛ M ( cathode )$$

Recharge:

βM+αLiF→αLi⁺+αe⁻+M_{β}F_{α} (cathode)

αLi⁺+αe⁻→αLi (anode)

Subsequent Discharge Operations

$${M}_{β} {F}_{α} + ϒ {Li}^{+} + ϒ {e}^{-} \to ϒ + ( 1 - \frac{ϒ}{α} ) {M}_{β} {F}_{α} + \frac{ϒ}{α} M ,$$

where 0<γ<2, 0<α<2, 0<β<1.

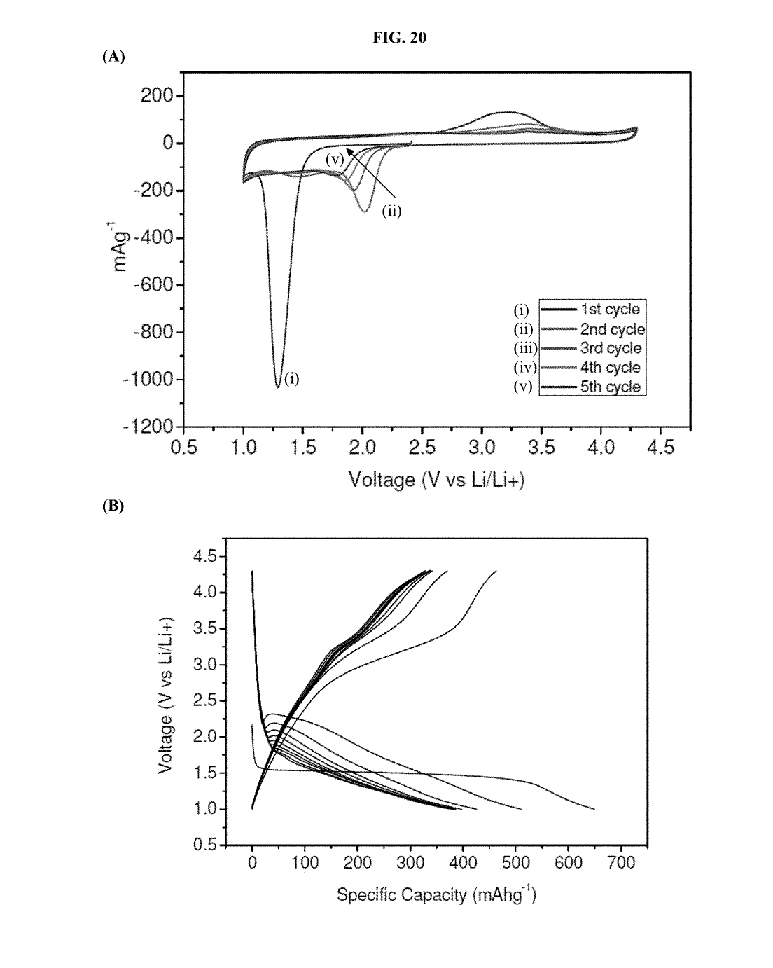

FIG. 20 shows (A) cyclic voltammogram at 0.1 mVs⁻¹; and (B) galvanostatic discharge-charge profile for operation of Li/LiPF₆/NiF₂.

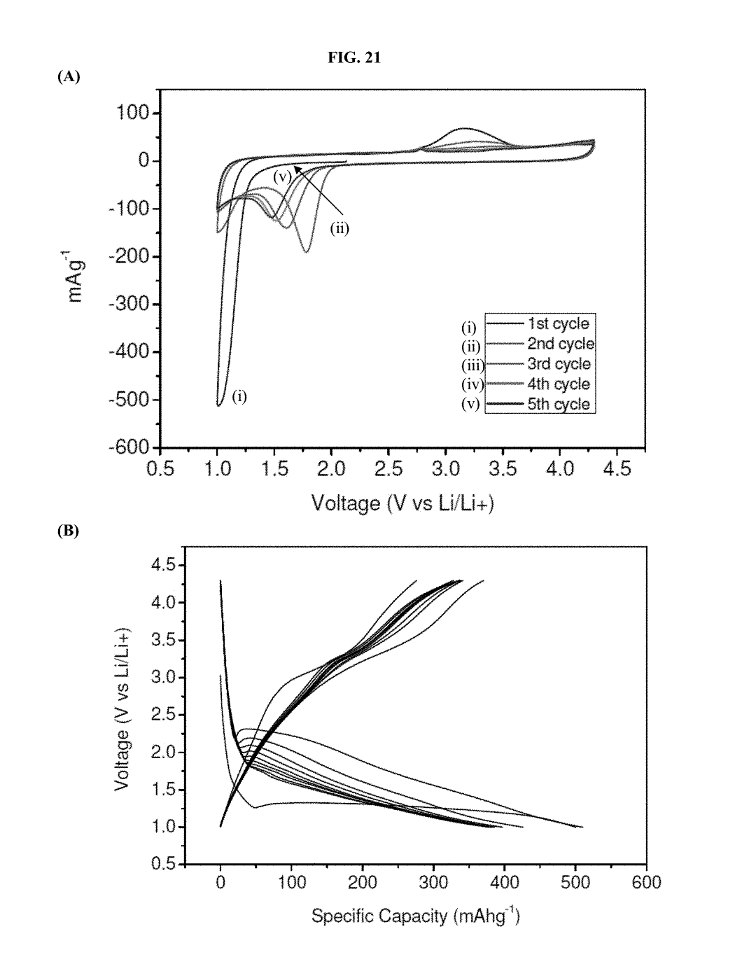

FIG. 21 shows (A) cyclic voltammogram at 0.1 mVs⁻¹; and (B) galvanostatic discharge-charge profile for operation of Li/LiPF₆/CoF₂.

### Example 11

### Cell Fabrication of Carbon Coated M^{(I)}ₓM^{(II)}₍₁₋ₓ₎F₂

M^{(I)}ₓM^{(II)}₍₁₋ₓ₎F₂ were handmixed with CNT or CNF. Amount of CNT or CNF added were in the range from 20 to 45 weight %. A binder was added to the carbon and M^{(I)}ₓM^{(II)}₍₁₋ₓ₎F₂ mixture The binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, was added to the carbon and M^{(I)}ₓM^{(II)}₍₁₋ₓ₎F₂ mixture. The amount of binder added ranged from 10 to 20%.

Composition of electrode in weight percent was as follows:

| | |
|---|---|
| Active material | 70 to 45% |
| Conductive carbon | 20 to 45% |
| Binder | 10 to 20% |

The electrode was coated onto a current collector. Choice of current collectors included aluminum, titanium, nickel, stainless steel, tantalum, carbon, graphite, and their respective alloys. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Anodes used or which may be used included lithium, carbon, lithium titanate, silicon, tin, and/or antimony.

Cell 2: Li/Electrolyte/M^{(I)}ₓM^{(II)}₍₁₋ₓ₎F₂

### First Operation: Discharge

$$ɛ Li \to ɛ {Li}^{+} + ɛ {e}^{-} ( anode )$$

$${M}_{x}^{( I )} {M}^{( II ) ( 1 - x )} {F}_{2} + ɛ {Li}^{+} + ɛ {e}^{-} \to ( 1 - \frac{ɛ}{2} ) {M}_{x}^{( I )} {M}_{( 1 - x )}^{( II )} {F}_{2} + ɛ LiF + \frac{ɛ x}{2} {M}^{( I )} + \frac{ɛ ( 1 - x )}{2} {M}^{( II )} ( cathode )$$

### Recharge:

βM^{(I)}+αLiF+γM^{(II)}→αLi⁺+αe⁻+M^{(I)}_{β}M^{(II)}_{γ}F_{α} (Cathode)

αLi⁺+αe⁻→αLi (anode)

Subsequent Discharge Operations

$${M}_{β}^{( I )} {M}_{γ}^{( II )} {F}_{α} + φ {Li}^{+} + φ {e}^{-} \to φ LiF + ( 1 - \frac{φ}{α} ) {M}_{β}^{( I )} {M}_{γ}^{( II )} {F}_{α} + \frac{φ β}{α} {M}^{( I )} + \frac{φ γ}{α} {M}^{( II )}$$

where 0<γ<2, 0<α<2, 0<β<1.

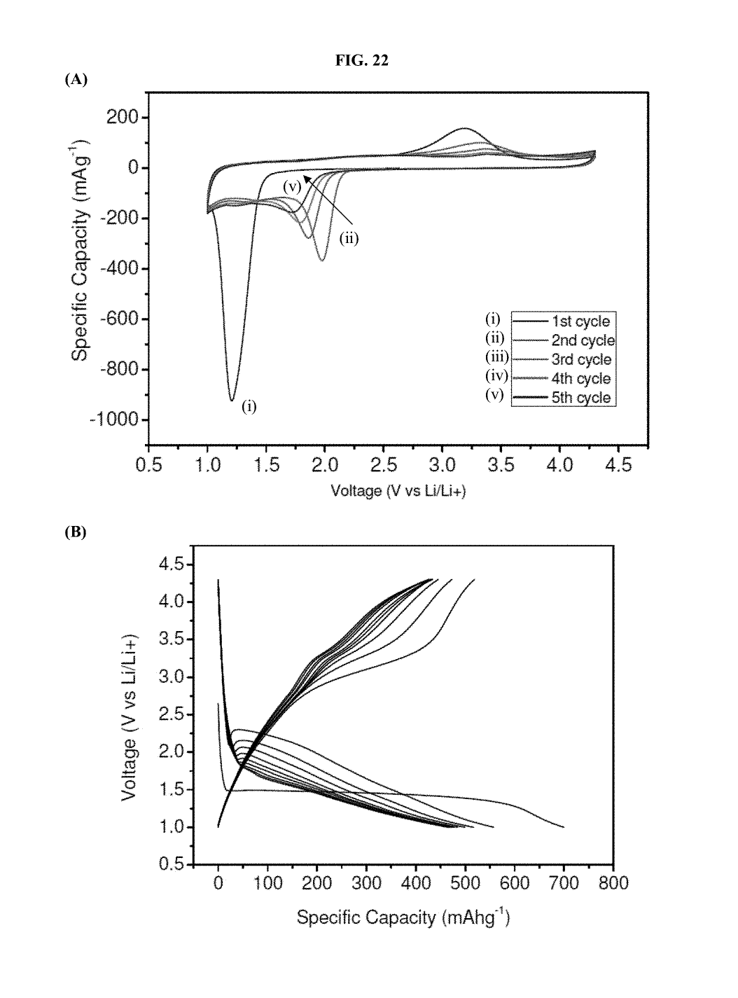

FIG. 22 shows (A) cyclic voltammogram at 0.1 mVs⁻¹; and (B) galvanostatic discharge-charge profile for operation of Li/LiPF₆/Ni_{0.75}Co_{0.25}F₂.

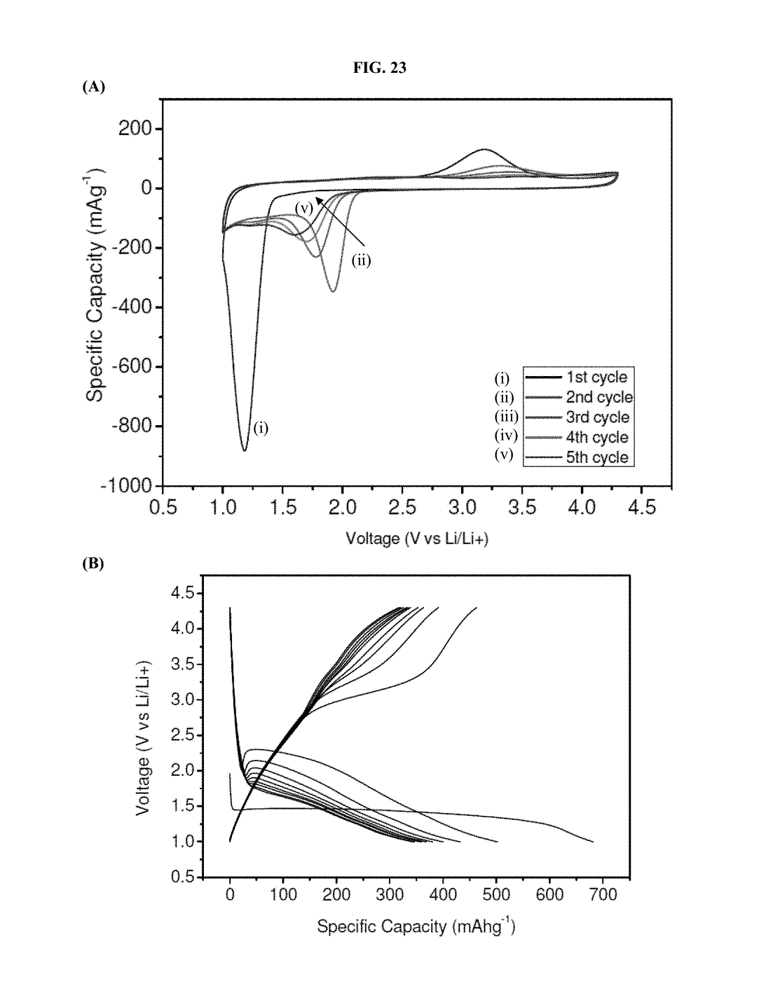

FIG. 23 shows (A) cyclic voltammogram at 0.1 mVs⁻¹; and (B) galvanostatic discharge-charge profile for operation of Li/LiPF₆/Ni_{0.5}Co_{0.5}F₂.

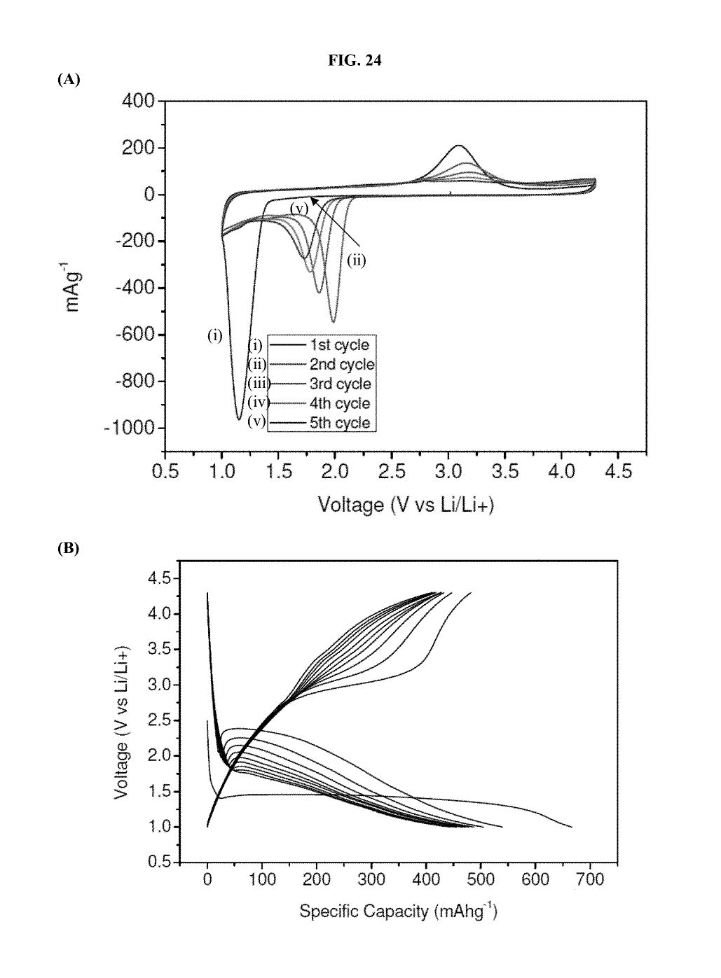

FIG. 24 shows (A) cyclic voltammogram at 0.1 mVs⁻¹; and (B) galvanostatic discharge-charge profile for operation of Li/LiPF₆/Ni_{0.25}Co_{0.75}F₂.

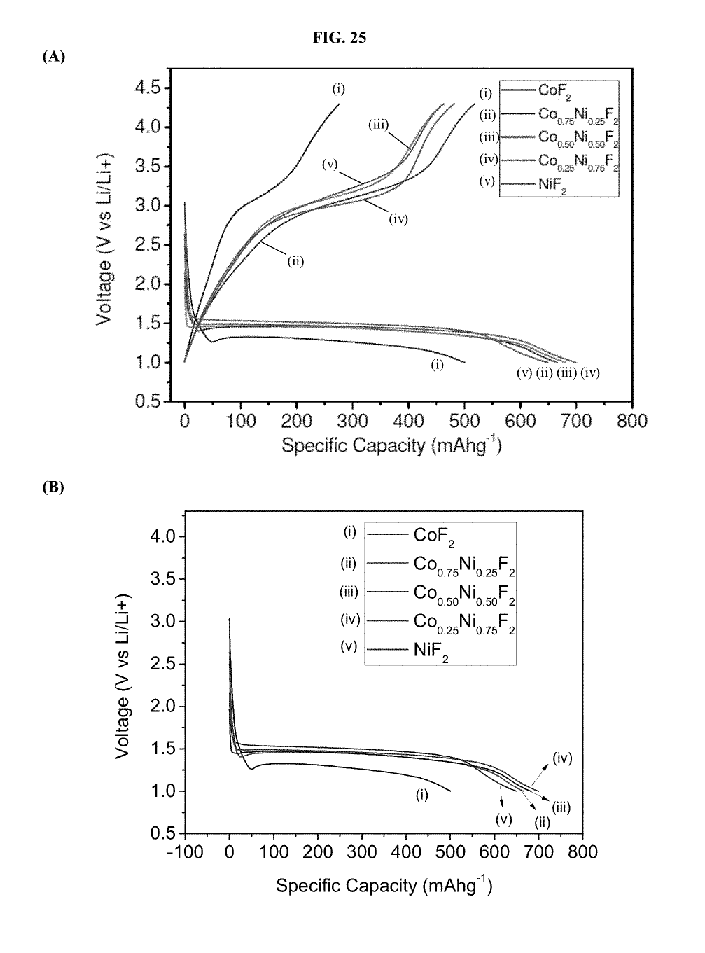

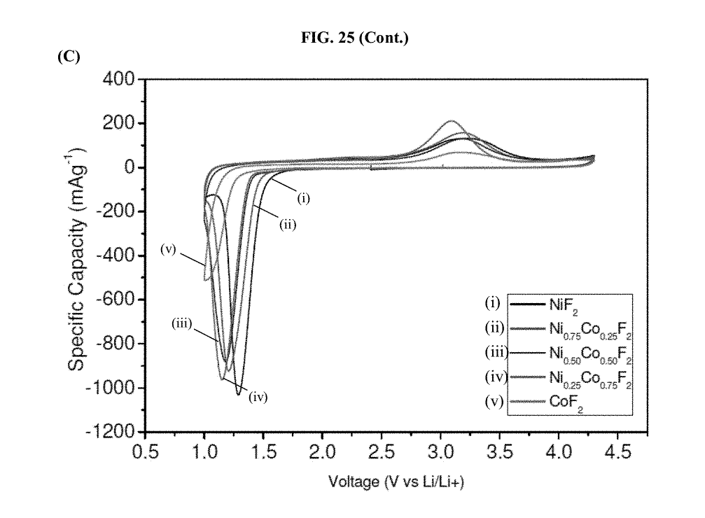

FIG. 25 shows 1^{st} cycle comparison of MF₂ with M^{(I)}ₓM^{(II)}₍₁₋ₓ₎F₂, where (A) is the 1^{st} cycle galvanostatic discharge-charge profile; (B) 1^{st} cycle galvanostatic discharge profile and (C) cyclic voltammogram at 0.1 mVs⁻¹.

### Example 12

### Cell Fabrication of Carbon Coated MF₂ Grown on Carbon Nanotubes or Carbon Nanofibers

A binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, was added to the MF₂-CNT/CNF nanostructure composite mixture. Amount of binder added ranged from 10 to 20%.

Composition of electrode in weight percent was as follows:

| | |
|---|---|
| MF₂-CNT/CNF nanostructure composite | 70 to 90% |
| Binder | 10 to 30% |

The electrode was coated onto a current collector. Choice of current collectors included aluminum, titanium, nickel, stainless steel, tantalum, carbon, graphite, and their respective alloys. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Anodes used or which may be used included lithium, carbon, lithium titanate, silicon, tin, and/or antimony.

Cell 3: Li/Electrolyte/MF₂-CNT/CNF Nanostructured Composite

### First Operation: Discharge

$$ɛ Li \to ɛ {Li}^{+} + ɛ {e}^{-} ( anode )$$

$$M {F}_{2} + ɛ {Li}^{+} + ɛ {e}^{-} \to ( 1 - \frac{ɛ}{2} ) M {F}_{2} + ɛ LiF + ɛ M ( cathode )$$

### Recharge:

βM+αLiF→αLi⁺+αe⁻+M_{β}F_{α} (Cathode)

αLi⁺+αe⁻→αLi (anode)

Subsequent Discharge Operations

$${M}_{β} {F}_{α} + ϒ {Li}^{+} + ϒ {e}^{-} \to ϒ LiF + ( 1 - \frac{ϒ}{α} ) {M}_{β} {F}_{α} + \frac{ϒ}{α} M ,$$

where 0<γ<2, 0<α<2, 0<β<1.

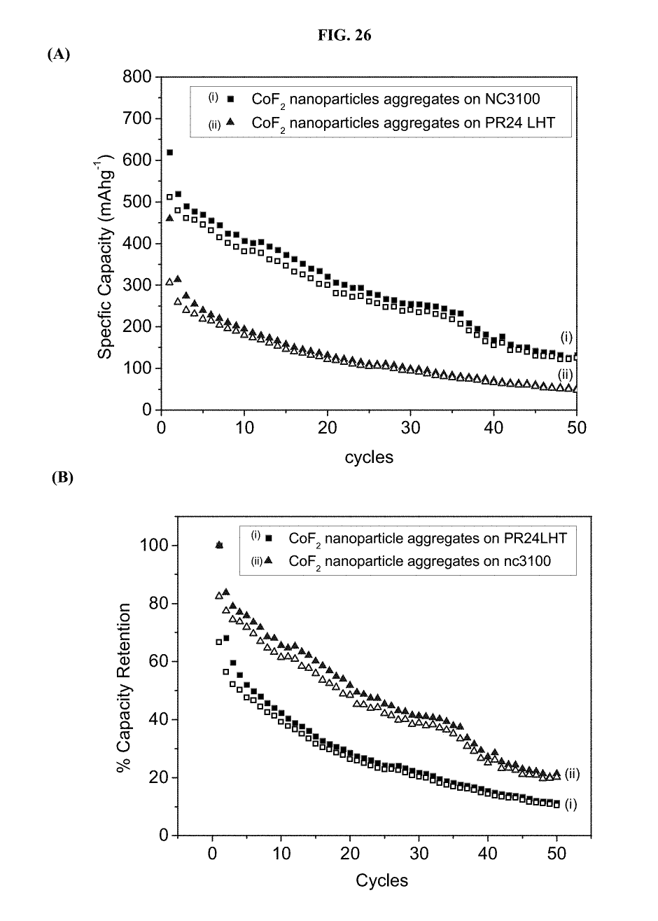

FIG. 26 shows long term cycling of CoF₂-CNT/CNF nanostructured composite, where (A) is the discharge-charge specific capacity of the CoF₂ nanoparticle aggregates deposited on CNT and CNF; and (B) is the % capacity retention of the CoF₂ nanoparticle aggregates deposited on CNT and CNF.

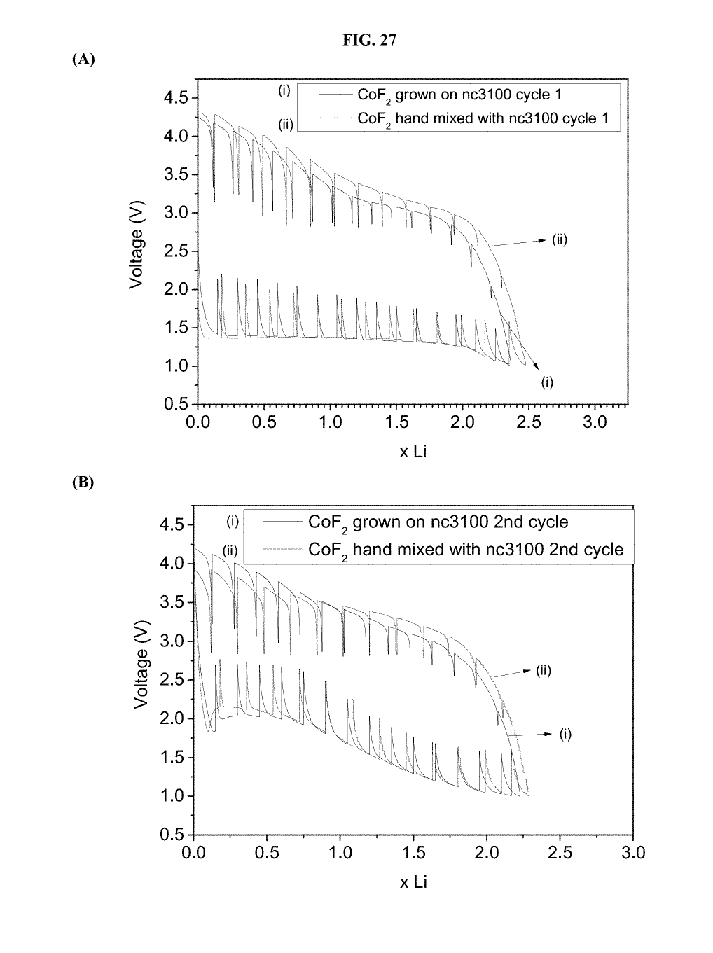

FIG. 27 shows GITT-effect of growing CoF₂ on CNT, where (A) is the comparison of the 1^{st} cycle galvanostatic intermittent titration curves for the CoF₂ nanoparticle aggregates deposited on CNT and CoF₂ nanoparticle aggregates hand mixed with CNT; and (B) is the comparison of the 2^{nd} cycle galvanostatic intermittent titration curves for the CoF₂ nanoparticle aggregates deposited on CNT and CoF₂ nanoparticle aggregates hand mixed with CNT.

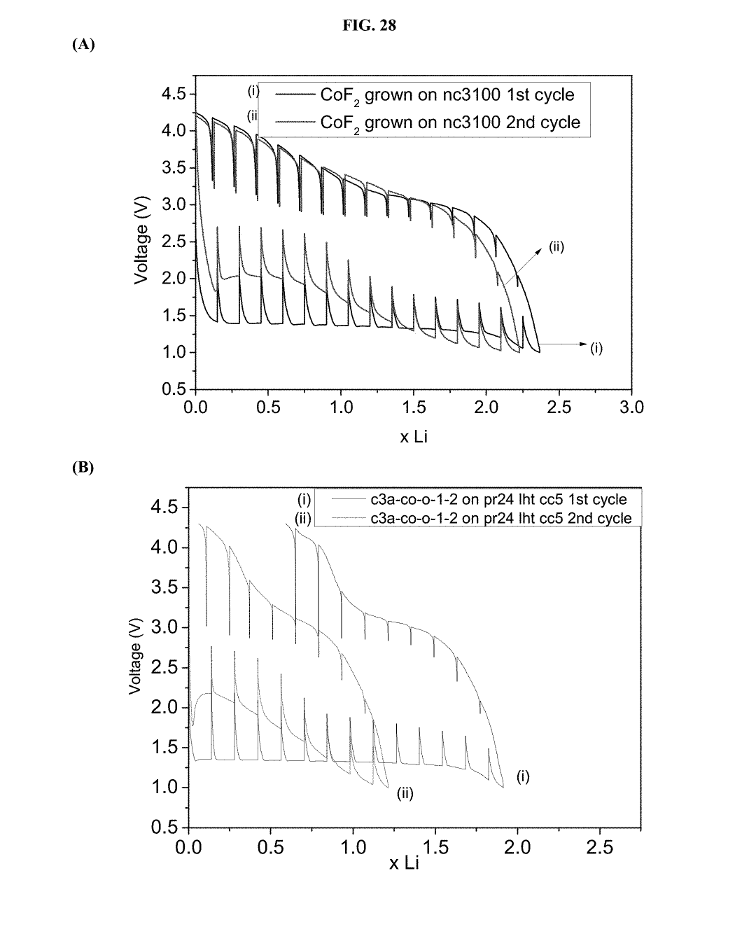

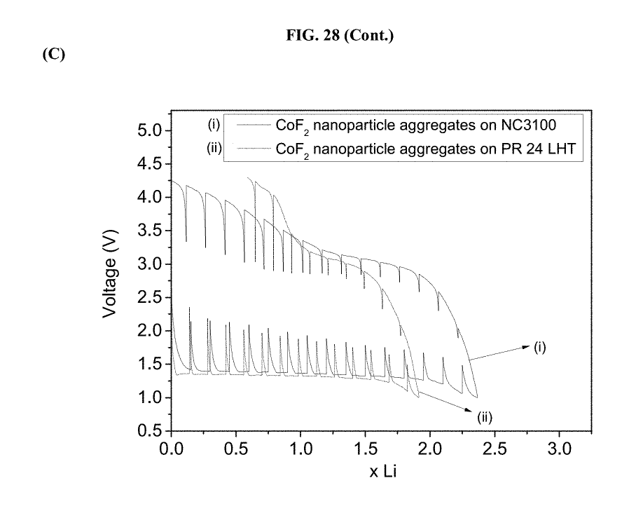

FIG. 28 shows GITT-effect of surface area, where (A) shows the 1^{st} and 2^{nd} cycles galvanostatic intermittent titration curves for the CoF₂ nanoparticle aggregates deposited on CNT; (B) shows the 1^{st} and 2^{nd} cycles galvanostatic intermittent titration curves for the CoF₂ nanoparticle aggregates deposited on CNF; and (C) is the comparison of the 1^{st} cycle galvanostatic intermittent titration curves between the CoF₂ nanoparticle aggregates deposited on CNT and CoF₂ nanoparticle aggregates deposited on CNF.

### Example 13

### Electrolyte Development

The electrolyte comprised of a solute and a solvent. The solvent may be a pure ionic liquid electrolyte, a blend of ionic liquid electrolytes, or a blend of organic solvents. The ionic liquid electrolyte used or in consideration may contain one or more of the following: BMIMBF₄, BMIMPF₆, EMIMBF₄, EMIMPF₆, PYR₁₄TFSI, PYR₁₃TFSI, EMIMTFSI, BMIMTFSI, [Et₃S][NTf₂], 11-methyl-3-octylimidazolium tetrafluoroborate, 1-butyl-1-methylpyrrolidinium bis(trifluoromethylsulfonyl)imide, 1-hexyl-3-methylimidazolium hexafluorophosphate, 1-Butyl-3-methylpyridinium bis(trifluoromethylsulfonyl)imide, methyl-trioctylammonium bis(trifluoromethyl-8 sulfonyl)imide.

The organic solvents used or in consideration may contain one or more of the following: solvent for the electrolyte may be propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), fluorinated propylene carbonate (FPC), or fluorinated ethylene carbonate (FEC).

Li-salt used or which may be used include one or more of lithium hexafluorophosphate (LiPF₆), lithium perchlorate (LiClO₄), lithium bis(trifluoromethanesulfonyl)imide (LiTFSI), or lithium tetrafluoroborate (LiBF₄).

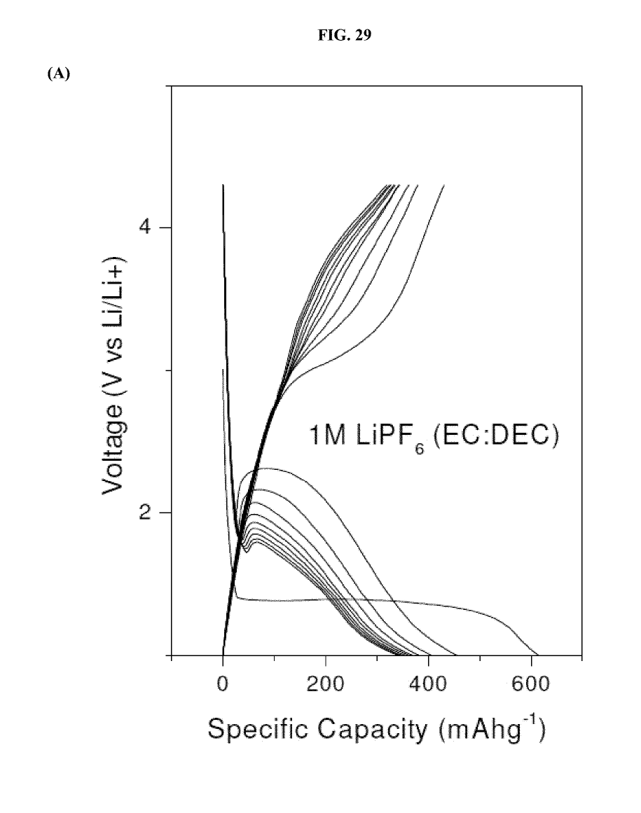

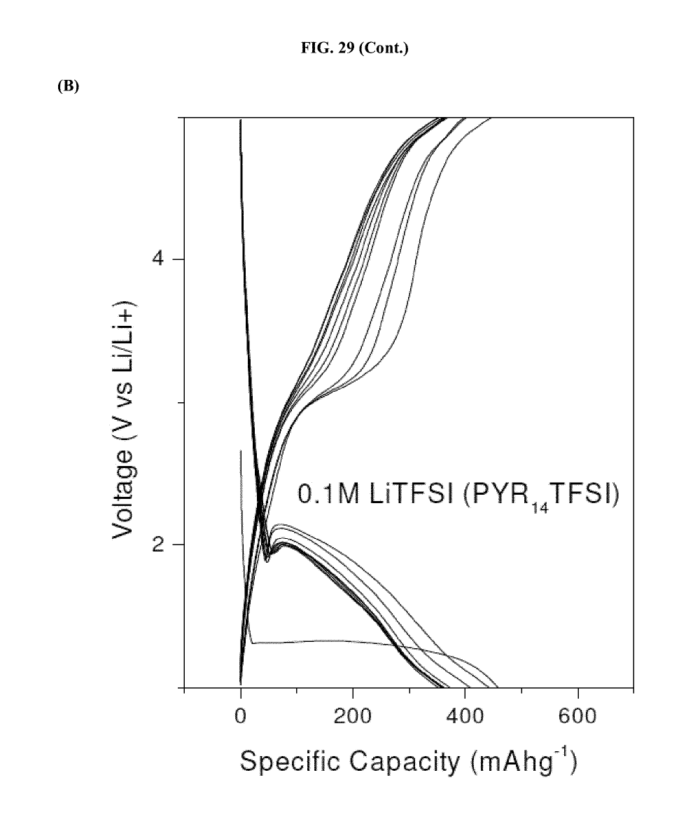

FIG. 29 shows effect of ionic liquid electrolyte as compared to conventional electrolyte, where (A) is the galvanostatic discharge-charge profile in conventional LiPF₆ (EC:DEC) (1:1 by volume) electrolyte; and (B) is the galvanostatic discharge-charge profile in 0.1M LiTFSI in PYR₁₄TFSI electrolyte.

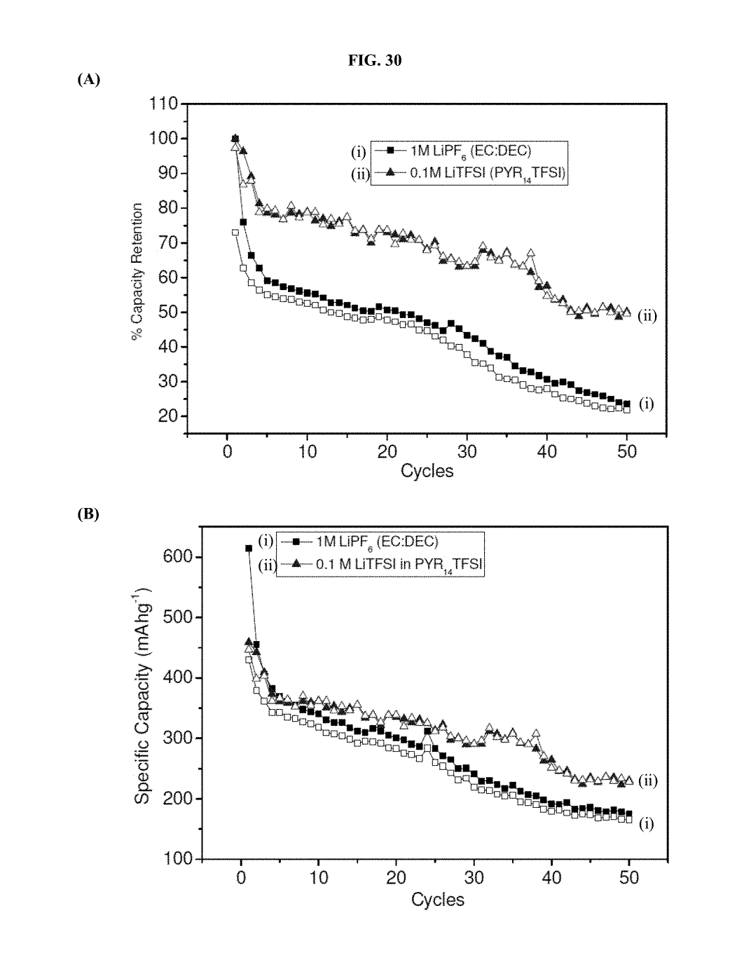

FIG. 30 shows effect of ionic liquid electrolyte as compared to conventional electrolyte, where (A) is a comparison of the % capacity retention between cells that use LiPF₆ (EC:DEC) (1:1 by volume) and cells that use 0.1M LiTFSI in PYR₁₄TFSI; and (B) shows the discharge-charge specific capacity of cells that use LiPF₆ (EC:DEC) (1:1 by volume) and cells that use 0.1M LiTFSI in PYR₁₄TFSI.

### Example 14

### Cell Fabrication of Non Carbon Coated MF_{2+y}

MF_{2+y} were ball-milled with conductive carbon. Amount of conductive carbon added ranged from 20 to 45 weight %. Conductive carbon used or which may be used included graphite, acetylene black, compressed acetylene black, super P, multiwall carbon nanotube, single wall carbon nanotube, carbon nanofiber, and/or blackpearl 2000.

A binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, or polytetrafluoroethylene (PTFE), was added to the carbon and MF_{2+y} mixture. Amount of binder added ranges from 10 to 20%.

Composition of electrode in weight percent was as follows:

| | |
|---|---|
| Active material | 70 to 45% |
| Conductive carbon | 20 to 45% |
| Binder | 10 to 20% |

The electrode was coated onto a current collector. Choice of current collectors included aluminum, titanium, nickel, stainless steel, tantalum, carbon, graphite, and their respective alloys. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Anodes used or which may be used included lithium, carbon, lithium titanate, silicon, tin, and/or antimony.

Cell 4: Li/Electrolyte/MF_{2+y} (Non Carbon Coated MF_{2+y})

### First Operation: Discharge

$$ɛ Li \to ɛ {Li}^{+} + ɛ {e}^{-} ( anode )$$

$${M F}_{2 + y} + ɛ {Li}^{+} + ɛ {e}^{-} \to {Li}_{ɛ} {M F}_{2 + y} ( cathode )$$

$${Li}_{ɛ} {M F}_{2 + y} + β {Li}^{+} + β {e}^{-} \to {Li}_{( ɛ - \frac{βɛ}{2} )} {M}_{( 1 - \frac{β}{2} )} {F}_{( 2 + y ) ( 1 - \frac{β}{2} )} + \frac{β}{2} M + ( β + \frac{β}{2} ) LiF ( cathode )$$

$$Assuming 2 + y = 3 , ɛ = 1$$

### Recharge:

$$\frac{β}{2} M + ( β + \frac{β}{2} ) Lif \to α {Li}^{+} + α {e}^{-} + ( β + \frac{β}{2} - α ) LiF + {M}_{γ} {F}_{α} + ( \frac{β}{2} - γ ) M ( Cathode )$$

$$α {Li}^{+} + α {e}^{-} \to α Li ( anode )$$

$$Assuming 2 + y = 3 , x = 1$$

FIG. 31 shows 1^{st} cycle comparison of (i) CoF₃ with (ii) CoF₂.

FIG. 32 shows CV 1^{st} cycle comparison of (i) CoF₃ with (ii) CoF₂.

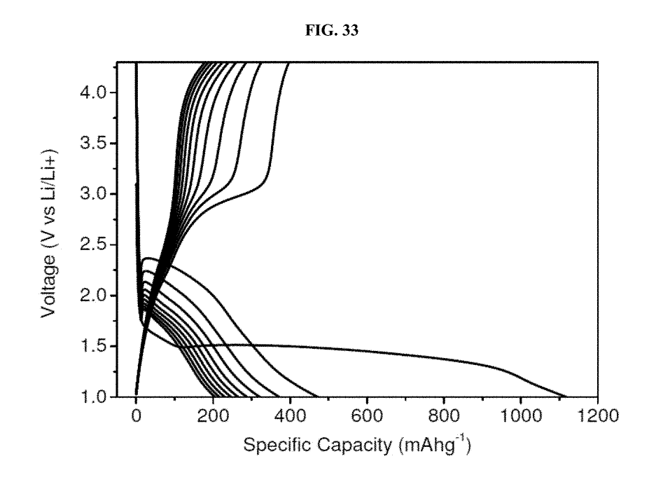

FIG. 33 shows operation of Li/LiPF₆/CoF₃ in LiPF₆ (FEC:EMC) (1:1) by weight.

Cell 5: Li/Electrolyte/MF_{2+y} (Non Carbon Coated MF_{2+y})

### First Operation: Discharge

$$ɛ Li \to ɛ {Li}^{+} + ɛ {e}^{-} ( anode )$$

$${M F}_{2 + y} + ɛ {Li}^{+} + ɛ {e}^{-} \to {Li}_{ɛ} {M F}_{2 + y} ( cathode )$$

$${Li}_{ɛ} M {F}_{2 + y} + β {Li}^{+} + β {e}^{-} \to {Li}_{( ɛ - \frac{βɛ}{2} )} {M}_{( 1 - \frac{β}{2} )} {F}_{( 2 + y ) ( 1 - \frac{β}{2} )} + \frac{β x}{2} M + \frac{β}{2} M + 2 β LiF ( cathode )$$

$$Assuming 2 + y = 4 , x = 2$$

### Recharge:

$$\frac{β x}{2} M + \frac{β}{2} M + 2 β LiF \to α {Li}^{+} + α {e}^{-} + ( 2 β - α ) LiF + {M}_{γ} {F}_{α} + ( \frac{β}{2} - γ ) M ( Cathode )$$

$$α {Li}^{+} + α {e}^{-} \to α Li ( anode )$$

$$Assuming 2 + y = 4 , x = 2$$

Cell 6: Li/Electrolyte/MF_{2+y} (Non Carbon Coated MF_{2+y})

### First Operation: Discharge

εLi→εLi⁺+xe⁻ (anode)

MF_{2+y}+εLi⁺+xe⁻Li_{ε}MF_{2+y} (cathode)

### Recharge:

Li_{ε}MF₂₊→MF_{2+y}+εLi⁺+xe⁻ (cathode)

εLi⁺+εe⁻→Li (anode)

where 4>2+y>2.

Cell 7: Anode/Electrolyte/LiₓMF_{2+y} (Non Carbon Coated MF_{2+y})

MF_{2+y} may be prelithiate either in a solvated lithium solution or in an electrochemical lithium half cell. The prelithiation in a solvated lithium solution may take place in the following manner:

MF_{2+y}+εLi−R→εMF_{2+y}+R,

where R=bi-phenyl, naphthalene, or butyl-lithium.

Alternatively, MF_{2+y} may also be prelithiated in an electrochemical half cell in a lithium-salt containing electrolyte where the anode may be lithium. Li-salt for the prelithiation may include lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

εLI→εLI⁺+εe⁻ (anode)

MF_{2+y}+εLi⁺+εe⁻→Li_{ε}MF_{2+y} (cathode)

### Recharge:

Li_{ε}MF_{2+y}+A→MF_{2+y}+Li_{ε}A
Where A=anode, and can be carbon, lithium titanate, silicon, tin, antimony.

where 4>2+y>2.

### Example 15

### Cell Fabrication of Carbon Coated MF_{2+y}

Carbon coated MF_{2+y} were ball-milled with conductive carbon. Amount of conductive carbon added ranged from 20 to 45 weight %. Conductive carbon used or which may be used included graphite, acetylene black, compressed acetylene black, super P, multiwall carbon nanotube, single wall carbon nanotube, carbon nanofiber, and/or blackpearl 2000.

A binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, or polytetrafluoroethylene (PTFE), was added to the carbon and MF_{2+y} mixture. Amount of binder added ranged from 10 to 20%.

Composition of electrode in weight percent was as follows:

| | |
|---|---|
| Active material | 70 to 45% |
| Conductive carbon | 20 to 45% |
| Binder | 10 to 20% |

The electrode was coated onto a current collector. Choice of current collectors included aluminum, titanium, nickel, stainless steel, tantalum, carbon, graphite, and their respective alloys. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Anodes used or which may be used included lithium, carbon, lithium titanate, silicon, tin, and/or antimony.

Cell 8: Li/Electrolyte/MF_{2+y} (Carbon Coated MF_{2+y})

### First Operation: Discharge

$$ɛ Li \to ɛ {Li}^{+} + ɛ {e}^{-} ( anode )$$

$${MF}_{2 + y} + ɛ {Li}^{+} + ɛ {e}^{-} \to {Li}_{ɛ} {MF}_{2 + y} ( cathode )$$

$${Li}_{ɛ} {MF}_{2 + y} + β {Li}^{+} + β {e}^{-} \to {Li}_{( ɛ - \frac{βɛ}{2} )} {M}_{( 1 - \frac{β}{2} )} {F}_{( 2 + y ) ( 1 - \frac{β}{2} )} + \frac{β}{2} M + ( β + \frac{β}{2} ) LiF ( cathode )$$

$$Assuming 2 + y = 3 , ɛ = 1$$

### Recharge:

$$\frac{β}{2} M + ( β + \frac{β}{2} ) LiF \to α {Li}^{+} + α {e}^{-} + ( β + \frac{β}{2} - α ) LiF + {M}_{γ} {F}_{α} + ( \frac{β}{2} - γ ) M ( Cathode )$$

$$α {Li}^{+} + α {e}^{-} \to α Li ( anode )$$

$$Assuming 2 + y = 3 , x = 1$$

Cell 9: Li/Electrolyte/MF_{2+y} (Carbon Coated MF_{2+y})

### First Operation: Discharge

$$ɛ Li \to ɛ {Li}^{+} + ɛ {e}^{-} ( anode )$$

$${M F}_{2 + y} + ɛ {Li}^{+} + ɛ {e}^{-} \to {Li}_{ɛ} {M F}_{2 + y} ( cathode )$$

$${Li}_{ɛ} M {F}_{2 + y} + β {Li}^{+} + β {e}^{-} \to {Li}_{( ɛ - \frac{βɛ}{2} )} {M}_{( 1 - \frac{β}{2} )} {F}_{( 2 + y ) ( 1 - \frac{β}{2} )} + \frac{β x}{2} M + \frac{β}{2} M + 2 β LiF ( cathode )$$

$$Assuming 2 + y = 4 , x = 2$$

### Recharge:

$$\frac{β x}{2} M + \frac{β}{2} M + 2 β LiF \to α {Li}^{+} + α {e}^{-} + ( 2 β - α ) LiF + {M}_{γ} {F}_{α} + ( \frac{β}{2} - γ ) M ( Cathode )$$

$$α {Li}^{+} + α {e}^{-} \to α Li ( anode )$$

$$Assuming 2 + y = 4 , x = 2$$

Cell 10: Li/Electrolyte/MF_{2+y} (Carbon Coated MF_{2+y})

### First Operation: Discharge

εLi→εLi⁺+xe⁻ (anode)

MF_{2+y}+εLi⁺+xe⁻→Li_{ε}MF_{2+y} (cathode)

### Recharge:

LiεMF₂₊→MF_{2+y}+εLi⁺+xe⁻ (cathode)

εLi⁺+εe⁻Li (anode)

where 4>2+y>2.

Cell 11: Anode/Electrolyte/LiₓMF_{2+y} (Carbon Coated MF_{2+y})

MF_{2+y} may be prelithiate either in a solvated lithium solution or in an electrochemical lithium half cell. The prelithiation in a solvated lithium solution may take place in the following manner:

MF_{2+y}+εLi−R→εMF_{2+y}+R,

where R=bi-phenyl, naphthalene, or butyl-lithium.

Alternatively, MF_{2+y} may also be prelithiated in an electrochemical half cell in a lithium-salt containing electrolyte where the anode may be lithium. Li-salt for the prelithiation may include lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

εLI→εLI⁺+εe⁻ (anode)

MF_{2+y}+εLi⁺+εe⁻→Li_{ε}MF_{2+y} (cathode)

### Recharge:

Li_{ε}MF_{2+y}+A→MF_{2+y}+Li_{ε}A
Where A=anode, and can be carbon, lithium titanate, silicon, tin, antimony.

where 4>2+y>2.

### Example 16

### Cell Fabrication of Non Carbon Coated M^{(I)}ₓM^{(II)}₍₁₋ₓ₎F_{2+y}

M^{(I)}ₓM^{(II)}₍₁₋ₓ₎F_{2+y} were ball-milled with conductive carbon. Amount of conductive carbon added ranged from 20 to 45 weight %.

Conductive carbon used or which may be used included graphite, acetylene black, compressed acetylene black, super P, multiwall carbon nanotube, single wall carbon nanotube, carbon nanofiber, and/or blackpearl 2000.

A binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, or polytetrafluoroethylene (PTFE), was added to the carbon and M^{(I)}ₓM^{(II)}₍₁₋ₓ₎F_{2+y} mixture. Amount of binder added ranged from 10 to 20%.

Composition of electrode in weight percent was as follows:

| | |
|---|---|
| Active material | 70 to 45% |
| Conductive carbon | 20 to 45% |
| Binder | 10 to 20% |

The electrode was coated onto a current collector. Choice of current collectors included aluminum, titanium, nickel, stainless steel, tantalum, carbon, graphite, and their respective alloys. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Anodes used or which may be used included lithium, carbon, lithium titanate, silicon, tin, and/or antimony.

Cell 12: Li/Electrolyte/M^{(I)}ₓM^{(II)}₍₁₋ₓ₎F_{2+y} (Non Carbon Coated M^{(I)}ₓM^{(II)}₍₁₋ₓ₎F_{2+y})

### First Operation: Discharge

$$ɛ Li \to ɛ {Li}^{+} + ɛ {e}^{-} ( anode )$$

$${M}_{x}^{( i )} {M}_{( 1 - x )}^{( II )} {F}_{2 + y} + ɛ {Li}^{+} + ɛ {e}^{-} \to {Li}_{ɛ} {M}_{x}^{( i )} {M}_{( 1 - x )}^{( II )} {F}_{2 + y} ( cathode )$$

$${Li}_{ɛ} {M}_{x}^{( i )} {M}_{( 1 - x )}^{( II )} {F}_{2 + y} + β {Li}^{+} + β {e}^{-} \to {Li}_{( ɛ - \frac{βɛ}{2} )} {M}_{( x - \frac{β}{2} )}^{( i )} {M}_{( 1 - \frac{β}{2} ) ( 1 - x )}^{( ii )} {F}_{( 2 + y ) ( 1 - \frac{β}{2} )} + \frac{β x}{2} {M}^{( i )} + \frac{β ( 1 - x )}{2} {M}^{( ii )} + ( β + \frac{β}{2} ) LiF ( cathode )$$

$$Assuming 2 + y = 3 , ɛ = 1$$

### Recharge:

$$\frac{β x}{2} {M}^{( i )} + \frac{β ( 1 - x )}{2} {M}^{( ii )} + ( β + \frac{β}{2} ) LiF \to α {Li}^{+} + α {e}^{-} + ( β + \frac{β}{2} - α ) LiF + {M}_{γ}^{( i )} {M}_{δ}^{( ii )} {F}_{α} + ( \frac{β x}{2} - γ ) {M}^{( i )} + ( \frac{β ( 1 - x )}{2} - δ ) {M}^{( ii )} ( Cathode )$$

$$α {Li}^{+} + α {e}^{-} \to α Li ( anode ) \\ Assuming 2 + y = 3 , x = 1$$

Cell 13: Li/Electrolyte/M^{(I)}ₓM^{(II)}₍₁₋ₓ₎F_{2+y} (Non Carbon Coated M^{(I)}ₓM^{(II)}₍₁₋ₓ₎F_{2+y})

### First Operation: Discharge

$$ɛ Li \to ɛ {Li}^{+} + ɛ {e}^{-} ( anode )$$

$${M}_{x}^{( I )} {M}_{( 1 - x )}^{( II )} {F}_{2 + y} + ɛ {Li}^{+} + ɛ {e}^{-} \to {Li}_{ɛ} {M}_{x}^{( I )} {M}_{( 1 - x )}^{( II )} {F}_{2 + y} ( cathode )$$

$${Li}_{ɛ} {M}_{x}^{( I )} {M}_{( 1 - x )}^{( II )} {F}_{2 + y} + β {Li}^{+} + β {e}^{-} \to {Li}_{( ɛ - \frac{βɛ}{2} )} {M}_{( x - \frac{β x}{2} )}^{( I )} {M}_{( 1 - \frac{β}{2} ) ( 1 - x )}^{( II )} {F}_{( 2 + y ) ( 1 - \frac{β}{2} )} + \frac{β x}{2} {M}^{( I )} + \frac{β ( 1 - x )}{2} {M}^{( II )} + 2 β LiF ( cathode )$$

$$Assuming 2 + y = 4 , x = 2$$

### Recharge:

$$\frac{β }{2} {M}^{( I )} + 2 β LiF \to α {Li}^{+} + α {e}^{-} + ( 2 β - α ) LiF + {M}_{γ}^{( I )} {M}_{δ}^{( II )} {F}_{α} + ( \frac{β x}{2} - γ ) {M}^{( I )} + ( \frac{β ( 1 - x )}{2} - δ ) {M}^{( II )} ( Cathode )$$

$$α {Li}^{+} + α {e}^{-} \to α Li ( anode ) \\ Assuming 2 + y = 4 , x = 2$$

Cell 14: Li/Electrolyte/M^{(I)}ₓM^{(II)}₍₁₋ₓ₎F_{2+y} (Non Carbon Coated M^{(I)}ₓM^{(II)}₍₁₋ₓ₎F_{2+y})

### First Operation: Discharge

εLi→εLi⁺+xe⁻ (anode)

M^{(I)}ₓM^{(II)}₍₁₋ₓ₎F_{2+y}+εLi⁺+xe⁻→Li_{ε}M^{(I)}ₓM^{(II)}₍₁₋ₓ₎F_{2+y} (cathode)

### Recharge:

Li_{ε}M^{(I)}ₓM^{(II)}₍₁₋ₓ₎F_{2+y}→M^{(I)}ₓM^{(II)}₍₁₋ₓ₎F_{2+y}+εLi⁺+xe⁻ (cathode)

εLi⁺+εe⁻→Li (anode)

where 4>2+y>2.

Cell 15: Anode/Electrolyte/Li_{ε}M^{(I)}ₓM^{(II)}₍₁₋ₓ₎F_{2+y} (Non Carbon Coated M^{(I)}ₓM^{(II)}₍₁₋ₓ₎F_{2+y})

M^{(I)}ₓM^{(II)}₍₁₋ₓ₎F_{2+y} may be prelithiate either in a solvated lithium solution or in an electrochemical lithium half cell. The prelithiation in a solvated lithium solution may take place in the following manner:

M^{(I)}ₓM^{(II)}₍₁₋ₓ₎F_{2+y}+εLi−R→Li_{ε}M^{(I)}ₓM^{(II)}₍₁₋ₓ₎F_{2+y}+R,

where R=bi-phenyl, naphthalene, or butyl-lithium.

Alternatively, M^{(I)}ₓM^{(II)}₍₁₋ₓ₎F_{2+y} may also be prelithiated in an electrochemical half cell in a lithium-salt containing electrolyte where the anode may be lithium. Li-salt for the prelithiation may include lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

xLI→xLI⁺+xe⁻ (anode)

M^{(I)}ₓM^{(II)}₍₁₋ₓ₎F_{2+y}+εLi⁺+xe⁻→Li_{ε}M^{(I)}ₓM^{(II)}₍₁₋ₓ₎F_{2+y} (cathode)

### Recharge:

Li_{ε}M^{(I)}ₓM^{(II)}₍₁₋ₓ₎F_{2+y}+A→M^{(I)}ₓM^{(II)}₍₁₋ₓ₎F_{2+y}+Li_{ε}A
Where A=anode, and can be carbon, lithium titanate, silicon, tin, antimony.

where 4>2+y>2.

### Example 17

### Cell Fabrication of Carbon Coated M^{(I)}ₓM^{(II)}₍₁₋ₓ₎F_{2+y}

Carbon coated M^{(I)}ₓM^{(II)}₍₁₋ₓ₎F_{2+y} were ball-milled with conductive carbon. Amount of conductive carbon added ranged from 20 to 45 weight %. Conductive carbon used or which may be used included graphite, acetylene black, compressed acetylene black, super P, multiwall carbon nanotube, single wall carbon nanotube, carbon nanofiber, and/or blackpearl 2000.

A binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, or polytetrafluoroethylene (PTFE), was added to the carbon and M^{(I)}ₓM^{(II)}₍₁₋ₓ₎F_{2+y} mixture. Amount of binder added ranged from 10 to 20%.

Composition of electrode in weight percent was as follows:

| | |
|---|---|
| Active material | 70 to 45% |
| Conductive carbon | 20 to 45% |
| Binder | 10 to 20% |

The electrode was coated onto a current collector. Choice of current collectors included aluminum, titanium, nickel, stainless steel, tantalum, carbon, graphite, and their respective alloys. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Anodes used or which may be used included lithium, carbon, lithium titanate, silicon, tin, and/or antimony.

Cell 16: Li/Electrolyte/M^{(I)}ₓM^{(II)}₍₁₋ₓ₎F_{2+y} (Carbon Coated M^{(I)}ₓM^{(II)}₍₁₋ₓ₎F_{2+y})

### First Operation: Discharge

$$ɛ Li \to ɛ {Li}^{+} + ɛ {e}^{-} ( anode )$$

$${M}_{x}^{( i )} {M}_{( 1 - x )}^{( II )} {F}_{2 + y} + ɛ {Li}^{+} + ɛ {e}^{-} \to {Li}_{ɛ} {M}_{x}^{( i )} {M}_{( 1 - x )}^{( II )} {F}_{2 + y} ( cathode )$$

$${Li}_{ɛ} {M}_{x}^{( ii )} {M}_{( 1 - x )}^{( II )} {F}_{2 + y} + β {Li}^{+} + β {e}^{-} \to {Li}_{( ɛ - \frac{βɛ}{2} )} {M}_{( x - \frac{β x}{2} )}^{( i )} {M}_{( 1 - \frac{β}{2} ) ( 1 - x )}^{( ii )} {F}_{( 2 + y ) ( 1 - \frac{β}{2} )} + \frac{β x}{2} {M}^{( i )} + \frac{β ( 1 - x )}{2} {M}^{( ii )} + ( β + \frac{β}{2} ) LiF ( cathode )$$

$$Assuming 2 + y = 3 , ɛ = 1$$

### Recharge:

$$\frac{β x}{2} {M}^{( i )} + \frac{β ( 1 - x )}{2} {M}^{( ii )} + ( β + \frac{β}{2} ) LiF \to α {Li}^{+} + α {e}^{-} + ( β + \frac{β}{2} - α ) LiF + {M}_{γ}^{( i )} {M}_{δ}^{( ii )} {F}_{α} + ( \frac{β x}{2} - γ ) {M}^{( i )} + ( \frac{β ( 1 - x )}{2} - δ ) {M}^{( ii )} ( Cathode )$$

$$α {Li}^{+} + α {e}^{-} \to α Li ( anode ) \\ Assuming 2 + y = 3 , x = 1$$

Cell 17: Li/Electrolyte/M^{(I)}ₓM^{(II)}₍₁₋ₓ₎F_{2+y} (Carbon Coated M^{(I)}ₓM^{(II)}₍₁₋ₓ₎F_{2+y})

### First Operation: Discharge

$$ɛ Li \to ɛ {Li}^{+} + ɛ {e}^{-} ( anode )$$

$${M}_{x}^{( I )} {M}_{( 1 - x )}^{( II )} {F}_{2 + y} + ɛ {Li}^{+} + ɛ {e}^{-} \to {Li}_{ɛ} {M}_{x}^{( I )} {M}_{( 1 - x )}^{( II )} {F}_{2 + y} ( cathode )$$

$${Li}_{ɛ} {M}_{x}^{( I )} {M}_{( 1 - x )}^{( II )} {F}_{2 + y} + β {Li}^{+} + β {e}^{-} \to {Li}_{( ɛ - \frac{βɛ}{2} )} {M}_{( x - \frac{β x}{2} )}^{( I )} {M}_{( 1 - \frac{β}{2} ) ( 1 - x )}^{( II )} {F}_{( 2 + y ) ( 1 - \frac{β}{2} )} + \frac{β x}{2} {M}^{( I )} + \frac{β ( 1 - x )}{2} {M}^{( II )} + 2 β LiF ( cathode )$$

$$Assuming 2 + y = 4 , x = 2$$

### Recharge:

$$\frac{β }{2} {M}^{( I )} + 2 β LiF \to α {Li}^{+} + α {e}^{-} + ( 2 β - α ) LiF + {M}_{γ}^{( I )} {M}_{δ}^{( II )} {F}_{α} + ( \frac{β x}{2} - γ ) {M}^{( I )} + ( \frac{β ( 1 - x )}{2} - δ ) {M}^{( II )} ( Cathode )$$

$$α {Li}^{+} + α {e}^{-} \to α Li ( anode ) \\ Assuming 2 + y = 4 , x = 2$$

Cell 18: Li/Electrolyte/M^{(I)}ₓM^{(II)}₍₁₋ₓ₎F_{2+y} (Carbon Coated M^{(I)}ₓM^{(II)}₍₁₋ₓ₎F_{2+y})

### First Operation: Discharge

εLi→εLi⁺+xe⁻ (anode)

M^{(I)}ₓM^{(II)}₍₁₋ₓ₎F_{2+y}+εLi⁺+xe⁻→Li_{ε}M^{(I)}ₓM^{(II)}₍₁₋ₓ₎F_{2+y} (cathode)

### Recharge:

Li_{ε}M^{(I)}ₓM^{(II)}₍₁₋ₓ₎F_{2+y}→M^{(I)}ₓM^{(II)}₍₁₋ₓ₎F_{2+y}+εLi⁺+xe⁻ (cathode)

εLi⁺+εe⁻→Li (anode)

where 4>2+y>2.

Cell 19: Anode/Electrolyte/Li_{ε}M^{(I)}ₓM^{(II)}₍₁₋ₓ₎F_{2+y} (Carbon Coated M^{(I)}ₓM^{(II)}₍₁₋ₓ₎F_{2+y})

M^{(I)}ₓM^{(II)}₍₁₋ₓ₎F_{2+y} were prelithiated either in a solvated lithium solution or in an electrochemical lithium half cell. The prelithiation in a solvated lithium solution may take place in the following manner:

M^{(I)}ₓM^{(II)}₍₁₋ₓ₎F_{2+y}+εLi−R→Li_{ε}M^{(I)}ₓM^{(II)}₍₁₋ₓ₎F_{2+y}+R

where R=bi-phenyl, naphthalene, or butyl-lithium.

Alternatively, M^{(I)}ₓM^{(II)}₍₁₋ₓ₎F_{2+y} may also be prelithiated in an electrochemical half cell in a lithium-salt containing electrolyte where the anode may be lithium. Li-salt for the prelithiation may include lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

xLI→xLI⁺+xe⁻ (anode)

M^{(I)}ₓM^{(II)}₍₁₋ₓ₎F_{2+y}+εLi⁺+xe⁻→Li_{ε}M^{(I)}ₓM^{(II)}₍₁₋ₓ₎F_{2+y} (cathode)

### Recharge:

Li_{ε}M^{(I)}ₓM^{(II)}₍₁₋ₓ₎F_{2+y}+A→M^{(I)}ₓM^{(II)}₍₁₋ₓ₎F_{2+y}+Li_{ε}A
Where A=anode, and can be carbon, lithium titanate, silicon, tin, antimony.

where 4>2+y>2.

### Example 18

### Cell Fabrication of Non Carbon Coated Blended Cathode

Blended cathode may contain MF_{2+y}, MF₂, M^{(I)}ₓM^{(II)}₍₁₋ₓ₎F_{2+y}, or M^{(I)}ₓM^{(II)}₍₁₋ₓ₎F₂ with a metal oxide or metal phosphate compound.

The metal oxide or metal phosphate may be lithium iron phosphate, lithium cobalt oxide, lithium manganese oxide, and/or lithium nickel manganese cobalt oxide. The composition of the metal oxide may range from 10 to 90 weight % out of the total weight of the active material.

The blended cathode may be ball-milled with conductive carbon. Amount of conductive carbon added ranged from 20 to 45 weight %. Conductive carbon used or which may be used included graphite, acetylene black, compressed acetylene black, super P, multiwall carbon nanotube, single wall carbon nanotube, carbon nanofiber, and/or blackpearl 2000.

A binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, or polytetrafluoroethylene (PTFE), was added to the carbon and blended cathode mixture. Amount of binder added ranged from 10 to 20%.

Composition of electrode in weight percent was as follows:

| | |
|---|---|
| Active material (containing blended metal fluoride with metal | 70 to 45% |
| oxide or metal phosphate) | |
| Conductive carbon | 20 to 45% |
| Binder | 10 to 20% |

The electrode was coated onto a current collector. Choice of current collectors included aluminum, titanium, nickel, stainless steel, tantalum, carbon, graphite, and their respective alloys. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Anodes used or which may be used included lithium, carbon, lithium titanate, silicon, tin, and/or antimony.

### Example 19

### Cell Fabrication of Carbon Coated Blended Cathode

Blended cathode may contain carbon coated MF_{2+y}, carbon coated MF₂, carbon coated M^{(I)}ₓM^{(II)}₍₁₋ₓ₎F_{2+y}, or carbon coated M^{(I)}ₓM^{(II)}₍₁₋ₓ₎F₂ with a metal oxide or metal phosphate compound.

The metal oxide or metal phosphate may be lithium iron phosphate, lithium cobalt oxide, lithium manganese oxide, and/or lithium nickel manganese cobalt oxide. The composition of the metal oxide may range from 10 to 90 weight % out of the total weight of the active material.

The blended cathode may be ball-milled or manually mixed with extra conductive carbon. Amount of extra conductive carbon added ranged from 20 to 45 weight %. Conductive carbon used or which may be used included graphite, acetylene black, compressed acetylene black, super P, multiwall carbon nanotube, single wall carbon nanotube, carbon nanofiber, and/or blackpearl 2000.

A binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, or polytetrafluoroethylene (PTFE), was added to the carbon and blended cathode mixture. Amount of binder added ranged from 10 to 20%.

Composition of electrode in weight percent was as follows:

| | |
|---|---|
| Active material (containing blended metal fluoride with anode | 70 to 45% |
| material) | |
| Conductive carbon | 20 to 45% |
| Binder | 10 to 20% |

The electrode was coated onto a current collector. Choice of current collectors included aluminum, titanium, nickel, stainless steel, tantalum, carbon, graphite, and their respective alloys. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Anodes used or which may be used included lithium, carbon, lithium titanate, silicon, tin, and/or antimony.

### Example 20

### Cell Fabrication of Non Carbon Coated Blended Anode

Blended anode may contain MF_{2+y}, MF₂, M^{(I)}ₓM^{(II)}₍₁₋ₓ₎F_{2+y}, or M^{(I)}ₓM^{(II)}₍₁₋ₓ₎F₂ with an anode material such as graphite, carbon nanotube, carbon nanofiber, CFₓ, lithium titanate, silicon, antimony, tin. The composition of the anode material may range from 10 to 90 weight percent out of total weight of the active material.

The blended anode may be ball-milled with conductive carbon. Amount of conductive carbon added ranged from 20 to 45 weight %. Conductive carbon used or which may be used included graphite, acetylene black, compressed acetylene black, super P, multiwall carbon nanotube, single wall carbon nanotube, carbon nanofiber, and/or blackpearl 2000.

A binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, or polytetrafluoroethylene (PTFE), was added to the carbon and blended anode mixture. Amount of binder added ranged from 10 to 20%.

Composition of electrode in weight percent was as follows:

| | |
|---|---|
| Active material (containing blended metal fluoride with anode | 70 to 45% |
| material) | |
| Conductive carbon | 20 to 45% |
| Binder | 10 to 20% |

The electrode was coated onto a current collector. Choice of current collectors included copper, stainless steel, carbon, graphite, and mixtures thereof. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Cathodes used or which may be used included lithium iron phosphate, lithium cobalt oxide, lithium manganese oxide, and/or lithium nickel manganese cobalt oxide.

### Example 21

### Cell Fabrication of Carbon Coated Blended Anode

Blended anode may contain carbon coated MF_{2+y}, carbon coated MF₂, carbon coated M^{(I)}ₓM^{(II)}₍₁₋ₓ₎F_{2+y}, or carbon coated M^{(I)}ₓM^{(II)}₍₁₋ₓ₎F₂ with an anode material such as graphite, carbon nanotube, carbon nanofiber, CFₓ, lithium titanate, silicon, antimony, and/or tin. The composition of the anode material may range from 10 to 90 weight percent out of total weight of the active material.

The blended anode may be ball-milled or manually mixed with extra conductive carbon. Amount of extra conductive carbon ranged from 20 to 45 weight %. Conductive carbon used or which may be used included graphite, acetylene black, compressed acetylene black, super P, multiwall carbon nanotube, single wall carbon nanotube, carbon nanofiber, and/or blackpearl 2000.

A binder, such as PVDF (polyvinylidene fluoride), PAN (polyacrylonitrile), PAA (poly(acrylic acid)), and/or PVDF-HFP (poly(vinylidene fluoride-co-hexafluoropropylene)), premixed with a solvent such as acetone, isopropanol, N-methyl-2-pyrrolidinone, and/or ethanol, or polytetrafluoroethylene (PTFE), was added to the carbon and blended anode mixture. Amount of binder added ranged from 10 to 20%.

Composition of electrode in weight percent was as follows:

| | |
|---|---|
| Active material (containing blended metal fluoride with anode | 70 to 45% |
| material) | |
| Conductive carbon | 20 to 45% |
| Binder | 10 to 20% |

The electrode was coated onto a current collector. Choice of current collectors included copper, stainless steel, carbon, graphite, and mixtures thereof. The electrode was dried at 80° C. on a heater, and subsequently roll pressed.

The electrode was formed into desirable geometry, and vacuum dried at 90° C. for 12 hours. The electrodes were assembled with a Li-salt containing electrolyte and an anode.

Li-salts used or which may be used included lithium hexafluorophosphate (LiPF₆), lithium perchlorate (LiClO₄), lithium bis(trifluoromethanesulfonyl)imide) (LiTFSI) and/or lithium tetrafluoroborate (LiBF₄).

Solvent for the electrolyte used or which may be used included propylene carbonate (PC), diethyl carbonate (DEC), dimethyl carbonate (DMC), ethylene carbonate:diethyl carbonate (EC:DEC), ethylene carbonate:dimethyl carbonate (EC:DMC), dimethyl ether (DME), ethyl methyl carbonate (EMC), or ionic liquids such as N-methyl pyrrolidinium bis(trifluoromethanesulfonyl)imide (PYR₁₃TFSI), PYR₁₄TFSI, 1-butyl-3-methylimidazolium tetrafluoroborate (BMIMBF₄), 1-butyl-3-methylimidazolium hexafluorophosphate (BMIMPF₆), 1-ethyl-3-methylimidazolium tetrafluoroborate (EMIMBF₄), and/or 1-ethyl-3-methylimidazolium hexafluorophosphate (EMIMPF₆).

Cathodes used or which may be used included lithium iron phosphate, lithium cobalt oxide, lithium manganese oxide, and/or lithium nickel manganese cobalt oxide.

### Example 22

### Fluoride Ion Batter (FIB) Based on MF₂ and M′F_{2+y} Electrodes (at Least One of M and M′ Comprises a Transition Metal)

An electrochemical cell was made using MF₂ and M′F_{2+y} electrodes as follows:
Electrode 1: uses carbon coated or carbon uncoated MF₂
Electrode 2: uses carbon coated or carbon uncoated M′F_{2+y} (0, y<2)
Electrolyte contains fluoride ions (F⁻). The cell structure is: MF₂/(F⁻) containing electrolyte/M′F_{2+y}.

The cell schematic reaction during first charge is:
Electrode 1: MF₂+ze⁻→MF_{2-z}+zF⁻(0<z<2)
Electrode 2: M′F_{2+y}+zF⁻→M′F_{2+y+z}+ze⁻

The cell schematic reaction during first discharge is
Electrode 1: MF_{2-z}+uF⁻→MF_{2-z+u}+ue⁻(0<u<2)
Electrode 2: M′F_{2+y+z}+ue⁻→M′F_{2+y+z-u}+uF⁻

The full FIB cell reaction in the following cycles is:
MF_{2-z}+M′F_{2+y+z} [symbol] MF_{2-z+u}+M′F_{2+y+z-u}

### Example 23

### Selective Deposition of Metal Fluorides on Exterior of Carbon Nanotube or Carbon Nanofiber

The first step is the acid treatment of the carbon nanotube (CNT) or carbon nanofiber (CNF). First, the MWCNT or CNF were refluxed in concentrated nitric acid (65.6% HNO₃) for 16 hours at 100° C. The CNT or CNF were neutralized with ammonium hydroxide after refluxing, and filtered using a vacuum pump. The collected CNT or CNF were left to dry in vacuum at 70° C. for 12 hours. The MWCNT or CNF were dispersed in octane.

The second step is blocking of the CNT or CNF interior using a suitable temperature solvent, followed by the precipitation of the metal fluorides on the exterior. Octane is used as the solvent for blocking the interior of the CNT or CNF to ensure that deposition of the CoF₂ nanoparticle aggregates are on the exterior of the CNT or CNF. 100 mg of the CNT or CNF were dispersed in 50 ml of octane using an ultrasonicator at 0.5 cycles, 50% amplitude for 3 minutes. Thereafter, 50 ml of ethanol is added into the MWCNT or CNF suspension. Typically, 1.446 millimoles of Co(NO₃)₂.6H₂O (Sigma Aldrich, ACS reagent, ≧98%) was dissolved in 2.9 ml of ethanol while 5.235 millimoles of NH₄F was dissolved in 2.6 ml of water. 2.610 millimoles of oleic acid was added to the Co(NO₃)₂.6H₂O solution as surfactant. Thereafter, the solutions were precipitated with slow rate to the MWCNT or CNF and stirred for 2 hours at 350 rpm. The samples were centrifuged and washed with ethanol several times. Collected samples were dried in vacuum at 70° C. for 12 hours. The samples were eventually heat treated in argon for about 2 hours at 400° C.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A nanocomposite comprising
a) an electrically conductive nanostructured material; and
b) metal fluoride nanostructures having the general formula M^{(I)}ₓM^{(II)}₍₁₋ₓ₎F_{2+y-zn} arranged on the electrically conductive nanostructured material,
wherein M^{(I)} and M^{(II)} are independently transition metals, n is a stoichiometric coefficient, and wherein
i) x=0, 0<y≦2, and z=0; or
ii) 0<x<1, 0≦y≦2, z≧0, and M^{(I)} and M^{(II)} are different transition metals.

2. The nanocomposite according to claim 1, wherein M^{(I)} and M^{(II)} are independently selected from the group consisting of Ti, V, Fe, Ni, Co, Mn, Cr, Cu, W, Mo, Nb, and Ta.

3. The nanocomposite according to claim 1 or 2, wherein M^{(I)} is Ni and M^{(II)} is Co.

4. The nanocomposite according to any one of claims 1 to 3, wherein the metal fluoride nanostructures comprise or consist of CoF₃.

5. The nanocomposite according to any one of claims 1 to 4, wherein the metal fluoride nanostructures comprise or consist of NiₓCo₁₋ₓF₂, 0<x<1.

6. The nanocomposite according to any one of claims 1 to 5, wherein the metal fluoride nanostructures comprise or consist of single phase metal fluoride nanostructures.

7. The nanocomposite according to any one of claims 1 to 6, wherein the metal fluoride nanostructures comprise an outer layer of carbon.

8. The nanocomposite according to any one of claims 1 to 7, wherein the metal fluoride nanostructures have a size of less than 200 nm.

9. The nanocomposite according to any one of claims 1 to 8, wherein the electrically conductive nanostructured material is selected from the group consisting of carbon nanotubes, carbon nanofibers, and mixtures thereof.

10. The nanocomposite according to any one of claims 1 to 9, wherein the metal fluoride nanostructures are arranged on an outer surface of the electrically conductive nanostructured material.

11. An electrode comprising a nanocomposite according to any one of claims 1 to 10.

12. The electrode according to claim 11, wherein amount of the electrically conductive nanostructured material in the electrode is in the range of about 20 wt % to about 45 wt %.

13. The electrode according to claim 11 or 12, further comprising a binder selected from the group consisting of polyvinylidene fluoride, polyacrylonitrile, poly(acrylic acid), poly(vinylidene fluoride-co-hexafluoropropylene), copolymers thereof, and mixtures thereof.

14. The electrode according to claim 13, wherein amount of binder in the electrode is in the range of about 10 wt % to about 20 wt %.

15. The electrode according to any one of claims 11 to 14, wherein the electrode is a cathode of a lithium battery.

16. A method of preparing a nanocomposite according to any one of claims 1 to 10, the method comprising
a) providing metal fluoride nanostructures having the general formula M^{(I)}ₓM^{(II)}₍₁₋ₓ₎F_{2+y-zn}, wherein M^{(I)} and M^{(II)} are independently transition metals, n is a stoichiometric coefficient, and wherein
i) x=0, 0<y≦2, and z=0; or
ii) 0<x<1, 0≦y≦2, z≧0, and M^{(I)} and M^{(II)} are different transition metals;
and
b) arranging the metal fluoride nanostructures on an electrically conductive nanostructured material to obtain the nanocomposite.

17. The method according to claim 16, wherein providing the metal fluoride nanostructures comprises fluorinating a metal salt with fluorine gas and/or a fluorination agent.

18. The method according to claim 17, wherein fluorinating the metal salt with fluorine gas and/or a fluorination agent is carried out by thermogravimetric means in a fluorine gas environment.

19. The method according to claim 17 or 18, wherein fluorinating the metal salt with fluorine gas and/or a fluorination agent is carried out at a temperature in the range of about 15° C. to about 600° C.

20. The method according to any one of claims 17 to 19, wherein fluorinating the metal salt with fluorine gas and/or a fluorination agent is carried out for a time period of about 120 hours or less.

21. The method according to any one of claims 17 to 20, wherein providing the metal fluoride nanostructures further comprises chemically reducing the metal fluoride nanostructures.

22. The method according to claim 21, wherein chemically reducing the metal fluoride nanostructures is carried out using a reducing agent selected from the group consisting of alkali metals, alkali earth metals, lanthanides, hydrogen, hydrazine, ammonia, amines, and combinations thereof.

23. The method according to claim 21 or 22, wherein chemically reducing the metal fluoride nanostructures is carried out using a reducing agent selected from the group consisting of Li-naphtalenide, Na-naphtalenide, Li-biphenyl, Na-biphenyl, butyl-lithium, butyl-sodium, and combinations thereof.

24. The method according to any one of claims 16 to 23, wherein providing the metal fluoride nanostructures comprises
a) adding a carbon precursor to metal fluoride nanostructures to form a mixture; and
b) calcining the mixture in an inert environment to form an outer layer of carbon on the metal fluoride nanostructures.

25. The method according to claim 24, wherein the carbon precursor is selected from the group consisting of sucrose, oleic acid, propanol, polyethylene glycol, glucose, octane, and mixtures thereof.

26. The method according to any one of claims 16 to 25, wherein arranging the metal fluoride nanostructures on an electrically conductive nanostructured material comprises forming the metal fluoride nanostructures in the presence of the electrically conductive nanostructured material and depositing the metal fluoride nanostructures on the electrically conductive nanostructured material.

27. The method according to any one of claims 16 to 26, wherein the electrically conductive nanostructured material is selected from the group consisting of carbon nanotubes, carbon nanofibers, and mixtures thereof.

28. The method according to claim 27, wherein the electrically conductive nanostructured material is dispersed in a solvent to fill an interior volume of the electrically conductive nanostructured material with the solvent prior to arranging the metal fluoride nanostructures on the electrically conductive nanostructured material.

29. The method according to claim 28, wherein the solvent comprises or consists of a C₆-C₁₀ alkane.

30. The method according to claim 28 or 29, wherein the solvent comprises or consists of octane.

31. Use of a nanocomposite according to any one of claims 1 to 10 in an electrochemical cell, a symmetric supercapacitor, an asymmetric supercapacitor, a primary battery, or a rechargeable battery.
